(19) United States
(12) Patent Application Publication
(10) Pub. No.: US 2015/0043944 A1
(43) Pub. Date: Feb. 12, 2015

(54) DEVELOPER SUPPLYING APPARATUS

(71) Applicant: CANON KABUSHIKI KAISHA, Tokyo (JP)

(72) Inventor: Tatsuyuki Yamamoto, Tokyo (JP)

(21) Appl. No.: 14/448,029

(22) Filed: Jul. 31, 2014

(30) Foreign Application Priority Data
Aug. 12, 2013 (JP) 2013-167338

(51) Int. Cl. G03G 15/08

(52) U.S. Cl. CPC G03G 21/1676; G03G 15/0867
USPC 399/258

(57) ABSTRACT

A supplying apparatus includes a mounting portion for mounting a developer supply container. The container includes a discharge opening; a receiving portion for receiving the developer, the receiving portion including a receiving opening and connectable with the discharge opening to receive the developer when the supply container is mounting to the mounting portion; a first moving mechanism for moving the receiving portion to and away from a position of the discharge opening in interrelation with mounting and demounting operation of the supply container; a covering member provided in a position opposing and above the receiving opening and movable between a covering position covering the receiving opening and an open position opening the receiving opening; and a second moving mechanism for moving the covering member from the covering position to the open position with the mounting operation of the supply container.

### FIELD OF THE INVENTION AND RELATED ART

The present invention relates to a developer supplying apparatus for supplying a developer in an image forming apparatus such as a copying machine, a printer, a facsimile machine, a complex machine thereof or the like which forms an image using a developer.

Conventionally, in the image forming apparatus of an electrophotographic type such as a copying machine, a developer in the form of fine particles such as toner powder is used. In such an image forming apparatus, the developer consumed in accordance with the image formation is compensated by a developer supplying apparatus. The supply of the developer is carried out by mounting a developer supply container accommodating the developer to a developer receiving portion provided in a main assembly of the apparatus. Here, since the developer is extremely fine powder, the developer may scatter during the mounting and demounting operation of the developer supply container. Therefore, various connecting types between the developer supply container and the developer receiving portion have been proposed and used (Japanese Laid-open Patent Application Hei 8-110692, for example).

With the structure disclosed in Japanese Laid-open Patent Application Hei 8-110692, the developer supply container accommodating the developer which is slidable relative to the main assembly, and in the state that the developer supply container is set in the main assembly, the discharge opening of the developer supply container is placed right above a receiving opening of the developing device. In developing operation, the whole developing device is moved up to place a discharge opening and the receiving opening in a connecting state (the openings are in fluid communication with each other). On the other hand, non-developing-operation period, the whole developing device is moved down to separate the receiving opening from the discharge opening.

However, with this structure, it is necessary to keep open the receiving opening, and therefore, foreign matter may enter through the receiving opening.

Under the circumstances, the present invention is to provide an apparatus with which a developer receiving portion having a receiving opening for receiving the developer is moved to connect the receiving opening to the discharge opening of a developer supply container, and the entering of the foreign matter through the receiving opening is suppressed.

### SUMMARY OF THE INVENTION

According to an aspect of the present invention, there is provided a supplying apparatus comprising a mounting portion configured to mount a supply container accommodating a developer, wherein said supply container includes a discharge opening detachably mountable to said mounting portion and configured to discharge the developer; a receiving portion capable of receiving the developer, said receiving portion including a receiving opening which opens upwardly and connectable with said discharge opening to receive the developer discharged through said discharge opening when said supply container is mounting to said mounting portion; a first moving mechanism configured to move said receiving portion to and away from a position of said discharge opening in interrelation with mounting and demounting operation of said supply container; a covering member provided in a position opposing and above said receiving opening and movable between a covering position covering said receiving opening and an open position opening said receiving opening; a second moving mechanism configured to move said covering member from the covering position to the open position with the mounting operation of said supply container.

Further features of the present invention will become apparent from the following description of exemplary embodiments with reference to the attached drawings.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic sectional view of an image forming apparatus to which the present invention is applicable.

FIG. 2 is a perspective view of the image forming apparatus.

FIG. 3 is a perspective view (a) and a sectional view (b).

FIG. 4 is a partial enlarged perspective view (a), a partial enlarged sectional view (b), and a developer receiving portion (c) of the developer receiving apparatus.

FIG. 5 is an exploded perspective view (a) and a perspective view (b) of the developer supply container.

FIG. 6 is a perspective view of a container body.

FIG. 7 is a perspective view (a), similar to FIG. 5, of an upper flange portion, and a perspective view (b) thereof as seen from a lower side of FIG. 5.

FIG. 8 is a perspective view (a), similar to FIG. 5, of a lower flange portion, a perspective view (b) thereof as seen from the lower side of FIG. 5 and a front view (c).

FIG. 9 is a top plan view (a) and a perspective view (b) of a shutter.

FIG. 10 is a perspective view (a) and a front view (b) of the pump.

FIG. 11 is a perspective view (a), similar to FIG. 5, of a reciprocating member, and a perspective view (b) thereof as seen from the lower side of FIG. 5.

FIG. 12 is a perspective view (a), similarly to FIG. 5, of a cover, and a perspective view (b) as seen the lower side of FIG. 5.

FIG. 13 is a partially sectional perspective view (a), a partially sectional front view (b) and a top plan view (c) of a developer supplying apparatus showing a first step of a mounting and demounting operation of the developer supply container, and an illustration of a relationship (d) between the lower flange portion and the developer receiving portion.

FIG. 14 is a partially sectional perspective view (a), a partially sectional front view (b) and a top plan view (c) of a developer supplying apparatus showing a second step of a mounting and demounting operation of the developer supply container, and a illustration of a relationship (d) between the lower flange portion and the developer receiving portion.

FIG. 15 is a partially sectional perspective view (a), a partially sectional front view (b) and a top plan view (c) of a developer supplying apparatus showing a third step of a mounting and demounting operation of the developer supply container, and a illustration of a relationship (d) between the lower flange portion and the developer receiving portion.

FIG. 16 is a partially sectional perspective view (a), a partially sectional front view (b) and a top plan view (c) of a developer supplying apparatus showing a fourth step of a mounting and demounting operation of the developer supply container, and a illustration of a relationship (d) between the lower flange portion and the developer receiving portion.

FIG. 17 is a timing chart of the mounting and demounting operation of the developer supply container.

FIG. 18 illustrates three modified examples of the guide portion of the developer supply container.

FIG. 19 is a perspective view of a part of the developer supplying apparatus according to a first embodiment of the present invention, in which (a) shows a state in which a covering member is in a covering position, and (b) shows an open position of the covering member, respectively.

FIG. 20 is a perspective view of a part of the developer supplying apparatus according to a second embodiment of the present invention, in which (a) shows a state in which a covering member is in a covering position, and (b) shows an open position of the covering member, respectively.

FIG. 21 is a perspective view of a part of the developer supplying apparatus according to a third embodiment of the present invention, in which (a) shows a state in which a covering member is in a covering position, (b) shows an open position of the covering member, respectively, and (c) shows a shaft and guiding grooves.

FIG. 22 is a perspective view of a part of the developer supplying apparatus according to a fourth embodiment of the present invention, in which (a) shows a state in which a covering member is in a covering position, and (b) shows an open position of the covering member, respectively.

### DESCRIPTION OF THE EMBODIMENTS

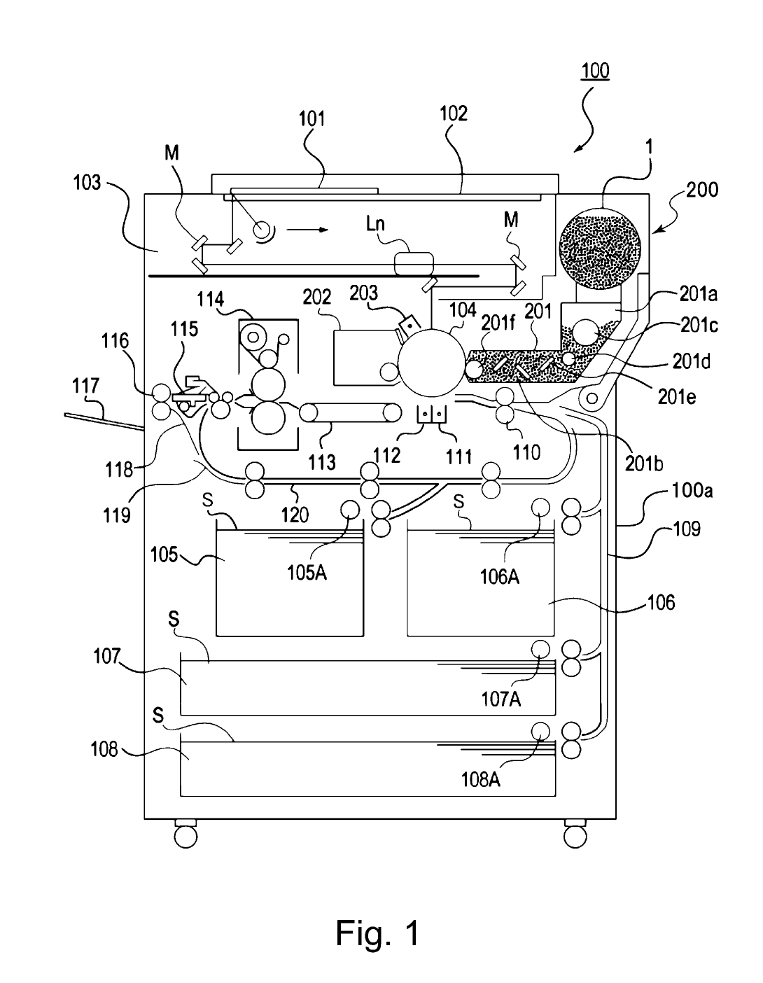

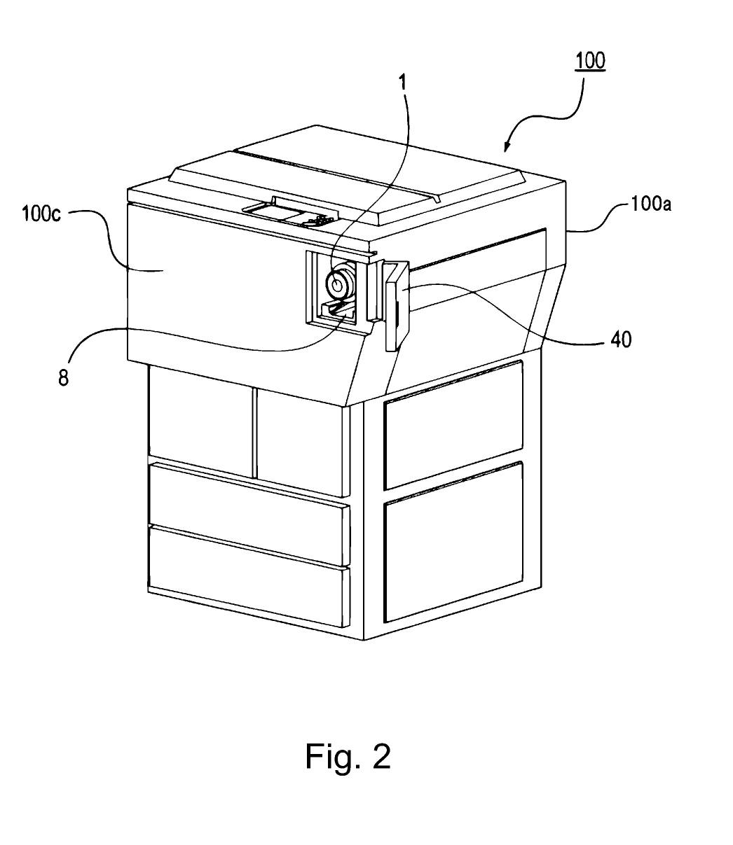

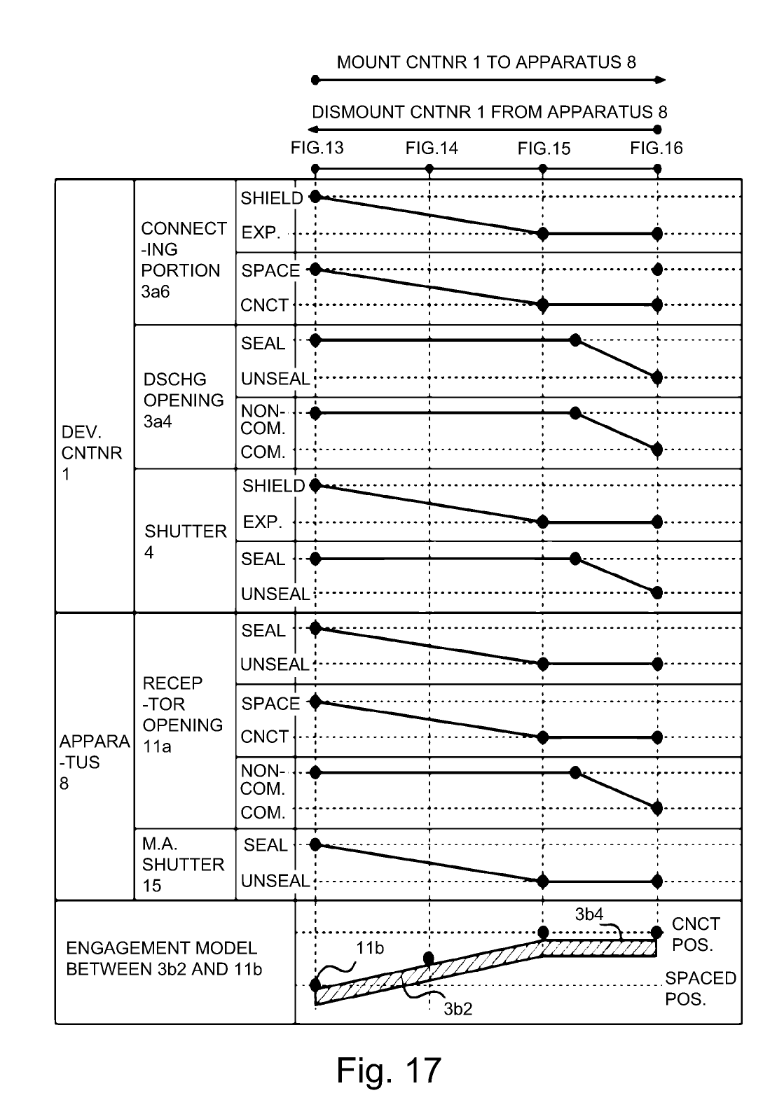

Referring to FIG. 1 to FIG. 18, an example of an image forming apparatus and a developer supplying apparatus to which the present invention is applicable. Referring first to FIGS. 1 and 2, a basic structure of such an image forming apparatus will be described.

### [Image Forming Apparatus]

In FIG. 1, designated by 100 is the image forming apparatus. Designated by 101 is an original placed on an original supporting platen glass 102. A light image corresponding to image information of the original is imaged on an electrophotographic photosensitive member 104 (photosensitive member) by way of a plurality of mirrors M of an optical portion 103 and a lens Ln, so that an electrostatic latent image is formed. The electrostatic latent image is visualized with toner (one component magnetic toner) as a developer (dry powder) by a dry type developing device (one component developing device) 201a. In this embodiment, the one component magnetic toner is used as the developer to be supplied from a developer supply container (toner cartridge) 1, but the present invention is not limited to the example and includes other examples which will be described hereinafter.

Specifically, in the case that a one component developing device using the one component non-magnetic toner is employed, the one component non-magnetic toner is supplied as the developer. In addition, in the case that a two component developing device using a two component developer containing mixed magnetic carrier and non-magnetic toner is employed, the non-magnetic toner is supplied as the developer. In such a case, both of the non-magnetic toner and the magnetic carrier may be supplied as the developer.

As described hereinbefore, the developing device 201 of FIG. 1 develops, using the developer, the electrostatic latent image formed on the photosensitive drum 104 on the basis of image information of the original 101. To the developing device 201, a developer supplying apparatus 200 is connected, and the developer supplying apparatus 200 comprises a developer supply container 1 and a developer receiving apparatus 8 to which the developer supply container 1 is detachably mountable. The developer supplying apparatus 200 will be described in detail hereinafter.

The developing device 201 is provided with a developing roller 201f in addition to the developer hopper portion 201a. The developer hopper portion 201a is provided with a stirring member 201c for stirring the developer supplied from the developer supply container 1. The developer stirred by the stirring member 201c is fed to the feeding member 201e by a feeding member 201d. The developer having been fed by the feeding members 201e, 201b in the order named is supplied finally to a developing zone relative to the photosensitive drum 104 while being carried on the developing roller 201f. In this example, the toner as the developer is supplied from the developer supply container 1 to the developing device 201, but another system may be used, and the toner and the carrier functioning developer may be supplied from the developer supply container 1, for example.

Designated by 105-108 in FIG. 1 are cassettes accommodating recording materials S such as sheets. Of the recording materials S stacked in the cassettes 105-108, a optimum cassette is selected on the basis of a sheet size of the original 101 or information inputted by the operator (user) from a liquid operating portion of the image forming apparatus. The recording material is not limited to a sheet of paper, but OHP sheet or another material can be used as desired. One recording material S supplied by a separation and feeding device 105A-108A is fed to registration rollers 110 along a feeding portion 109, and is fed at timing synchronized with rotation of a photosensitive drum 104 and with scanning of an optical portion 103.

Designated by 111, 112 are a transfer charger and a separation charger. An image (toner image) of the developer formed on the photosensitive drum 104 is transferred onto the recording material S by a transfer charger 111. The recording material S carrying the toner image it is separated from the photosensitive drum 104 by a separation charger 112. Thereafter, the recording material S fed by the feeding portion 113 is subjected to heat and pressure in a fixing portion 114 so that the developed image on the recording material is fixed, and then passes through a discharging/reversing portion 115, in the case of one-sided copy mode, and subsequently the sheet S is discharged to a discharging tray 117 by discharging rollers 116.

On the other hand, in the case of a duplex copy, the recording material S is fed through the discharging/reversing portion 115, and a part of the recording material S is temporarily discharged to an outside by a discharging roller 116. The trailing end of the recording material S passes through a flapper 118, and a flapper 118 is controlled when it is still nipped by the discharging rollers 116, and the discharging rollers 116 are rotated reversely, so that the recording material S is refed into the apparatus. Then, the sheet S is fed to the registration rollers 110 by way of re-feeding portions 119, 120, and then conveyed along the path similarly to the case of the one-sided copy mode and is discharged to the discharging tray 117.

In the image forming apparatus 100 having such a structure, around the photosensitive drum 104, there are provided image forming process equipment such as a developing device 201a as the developing means a cleaner portion 202 as a cleaning means, a primary charger 203 as charging means. The developing device 201 develops the electrostatic latent image formed on the photosensitive drum 104 by the optical portion 103 in accordance with image information of the 101, by depositing the developer onto the latent image. The primary charger 203 uniformly charges a surface of the photosensitive drum for the purpose of forming a desired electrostatic image on the photosensitive drum 104. The cleaner portion 202 removes the developer remaining on the photosensitive drum 104.

As shown in FIG. 2, when a exchange cover 40 which is a part of a outer casing of the main assembly 100a of the image forming apparatus 100, a part of a developer receiving apparatus 8 is exposed. By inserting (mounting) the developer supply container 1 into the developer receiving apparatus 8, the developer supply container 1 is set in the state capable of supplying the developer into the developer receiving apparatus 8. On the other hand, when the operator exchanges the developer supply container 1 the developer supply container 1 is taken out (disengaged) from the developer receiving apparatus 8 through the operation reciprocal to the mounting operation, and a new developer supply container 1 is set. Here, the exchange cover 40 is exclusively for mounting and demounting (exchange) of the developer supply container 1, and is opened and closed for mounting and demounting the developer supply container 1. For other maintenance operations for the apparatus 100, a front cover 100c is opened and closed. The exchange cover 40 and the front cover 100c may be made integral with each other, and in this case, the exchange of the developer supply container 1 and the maintenance of the image forming apparatus 100 are carried out with opening and closing of the integral cover (unshown).

### [Developer Receiving Apparatus]

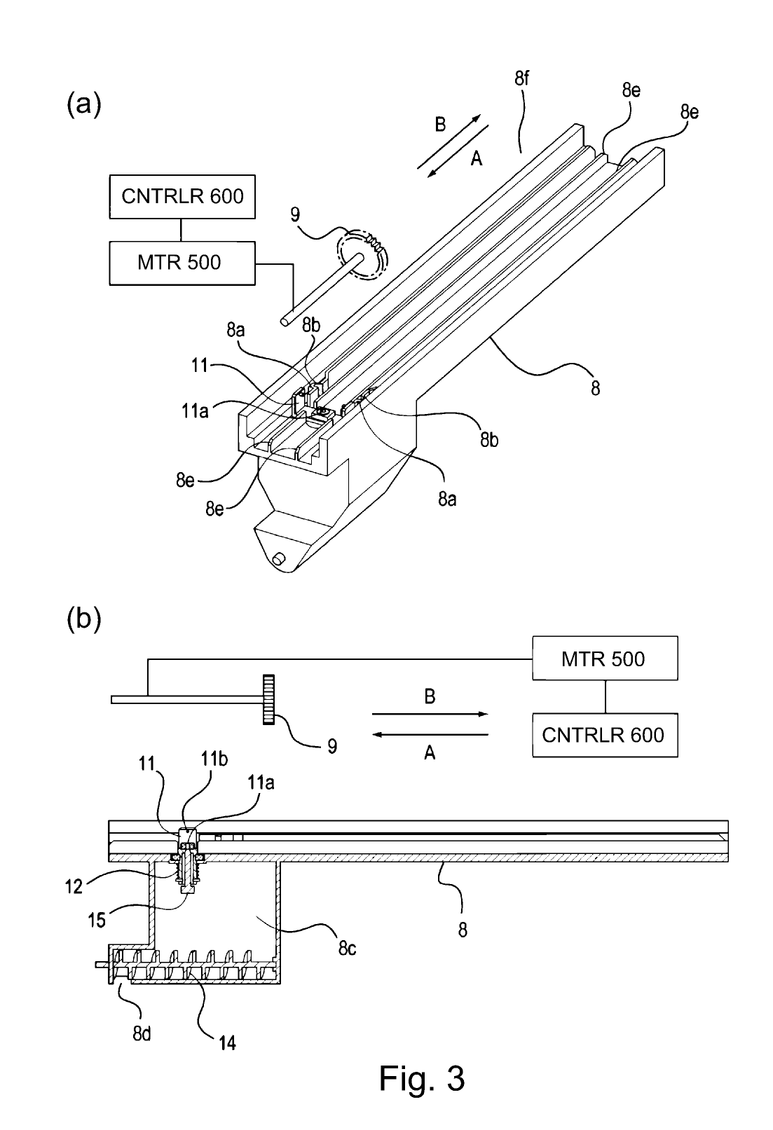

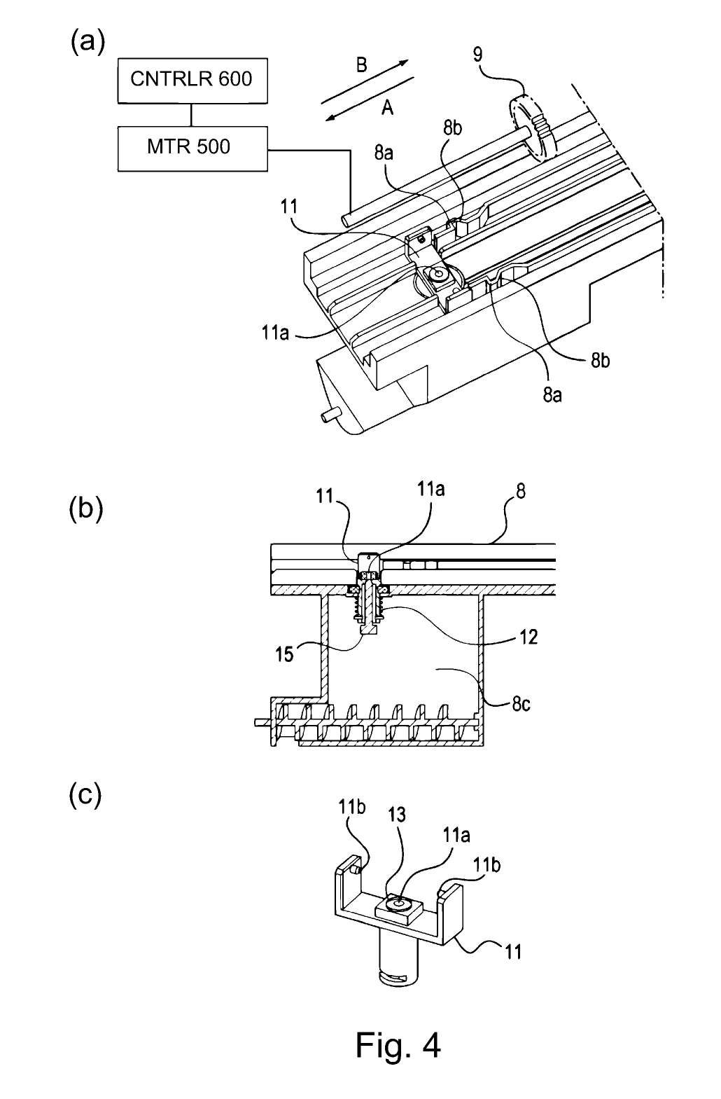

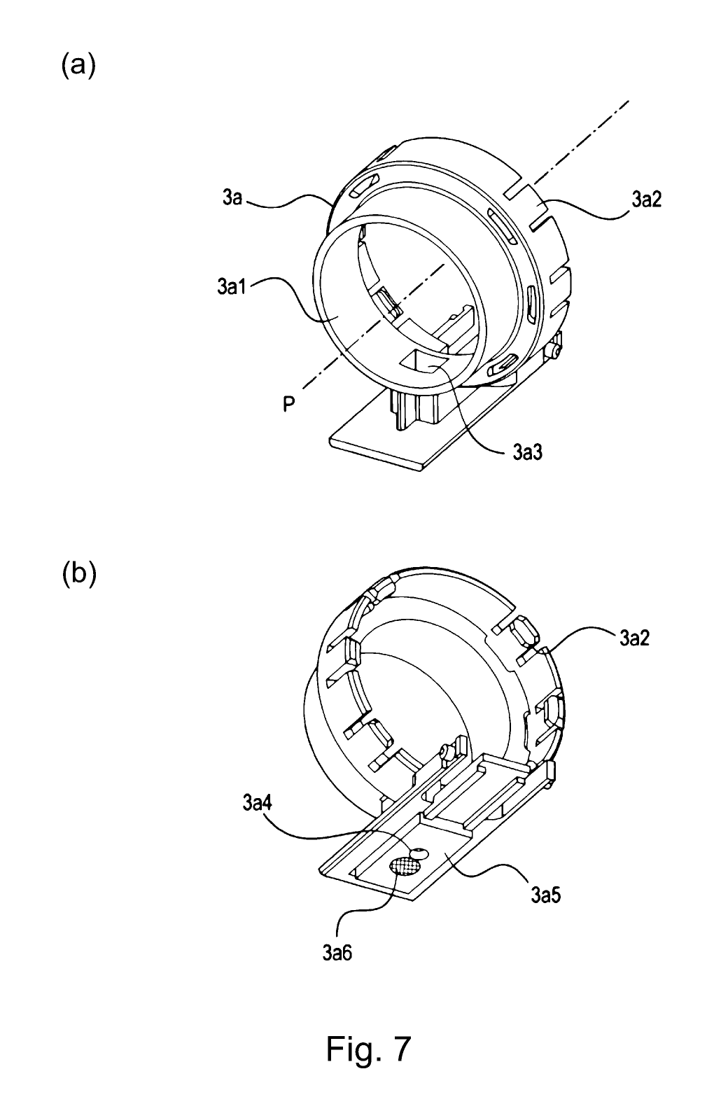

Referring to FIGS. 3 and 4 the developer receiving apparatus 8 will be described. As shown in part (a) of FIG. 3, the developer receiving apparatus 8 is provided with a mounting portion (mounting space) 8f into which the developer supply container 1 is removably (detachably) mounted. It is also provided with a developer receiving portion 11 for receiving the developer discharged through a discharge opening 3a4 (part (b) of FIG. 7), which will be described hereinafter, of the developer supply container 1.

The developer receiving portion 11 is capable of receiving the developer supply container 1 and is provided with a developer receiving opening 11a for receiving the developer through the discharge opening 3a4 and the discharge opening 3a4 connected with each other, when it receives the developer supply container 1. In addition, the developer receiving portion 11 is mounted so as to be movable (displaceable) in a direction in which the developer receiving opening 11a moves to and away from the discharge opening 3a4, that is, in the direction crossing with a mounting and demounting direction of the developer supply container (more specifically, the vertical direction relative to the developer receiving apparatus 8) in this example.

As shown in part (c) of FIG. 4, the developer receiving portion 11 is provided with a main assembly seal 13 having a developer receiving opening 11a at the central portion thereof. The main assembly seal 13 is made of an elastic member, a foam member or the like, and is close-contacted with an opening seal 3a5 (part (b) of FIG. 7) having a discharge opening 3a4 of the developer supply container 1, by which the developer discharged through the discharge opening 3a4 is prevented from leaking out of a developer feeding path including developer receiving opening 11a.

In order to prevent the contamination in the mounting portion 8f by the developer as much as possible, a diameter of the developer receiving opening 11a is desirably substantially the same as or slightly larger than a diameter of the discharge opening 3a4 of the developer supply container 1. This is because if the diameter of the developer receiving opening 11a is smaller than the diameter of the discharge opening 3a4, the developer discharged from the developer supply container 1 is easily deposited on the upper surface of the main assembly seal 13 having the developer receiving opening 11a. The deposited developer is transferred onto the lower surface of the developer supply container 1 during the dismounting operation of the developer supply container 1, with the result of contamination with the developer. In addition, the developer transferred onto the developer supply container 1 may be scattered to the mounting portion 8f with the result of contamination of the mounting portion 8f with the developer.

On the contrary, if the diameter of the developer receiving opening 11a is quite larger than the diameter of the discharge opening 3a4, an area in which the developer scattered from the developer receiving opening 11a is deposited around the discharge opening 3a4 formed in the opening seal 3a5 is large. That is, the contaminated area of the developer supply container 1 by the developer is large, which is not preferable. Under the circumstances, the difference between the diameter of the developer receiving opening 11a and the diameter of the discharge opening 3a4 is preferably substantially 0 to approx. 2 mm. In this example, the diameter of the discharge opening 3a4 of the developer supply container 1 is approx. φ2 mm (pin hole), and therefore, the diameter of the developer receiving opening 11a is approx. φ3 mm.

Furthermore, as shown in part (b) of FIG. 3, the developer receiving portion 11 is urged by an urging member 12 in the direction such that the developer receiving opening 11a tends to be away from the discharge opening 3a4 (more specifically, downward). In other words, when the developer receiving opening 11a moves toward the discharge opening 3a4 (more specifically, upward), the developer receiving portion 11 moves against an urging force of the urging member 12.

As shown in part (b) of FIG. 3, below the developer receiving apparatus 8, there is provided a sub-hopper 8c for temporarily storing the developer. In the sub-hopper 8c, there are provided a feeding screw 14 for feeding the developer into the developer hopper portion 201a which is a part of the developing device 201, and an opening 8d which is in fluid communication with the developer hopper portion 201a.

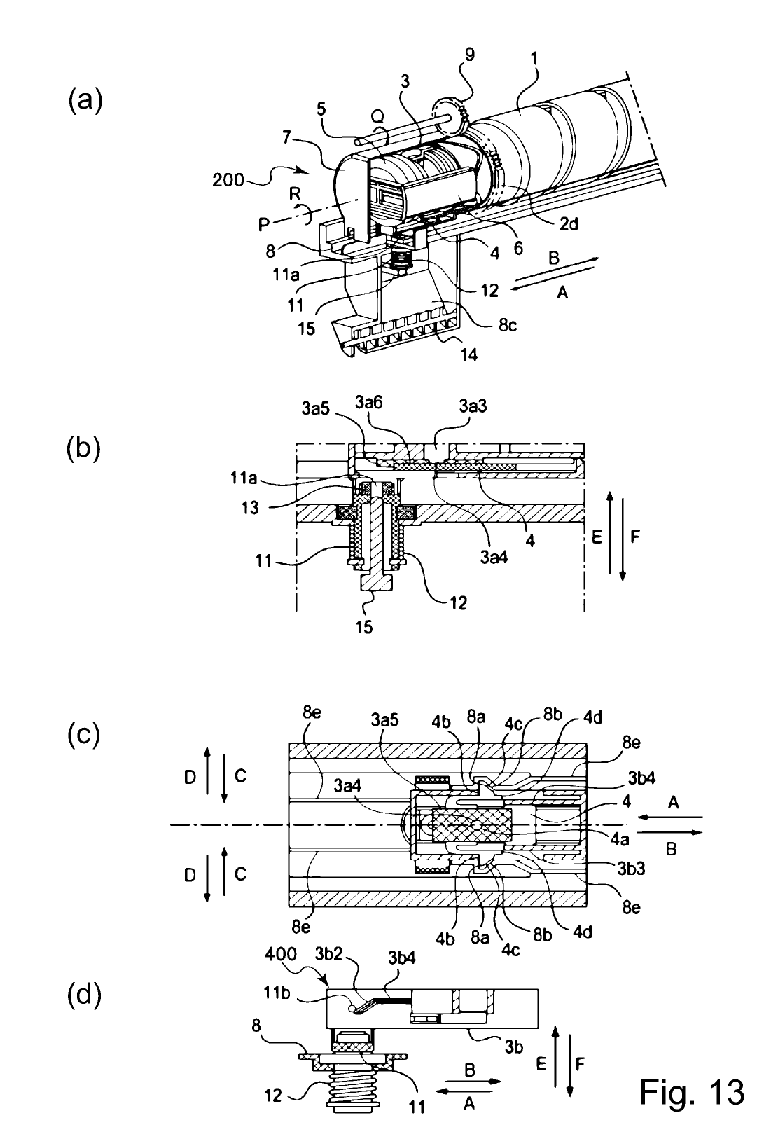

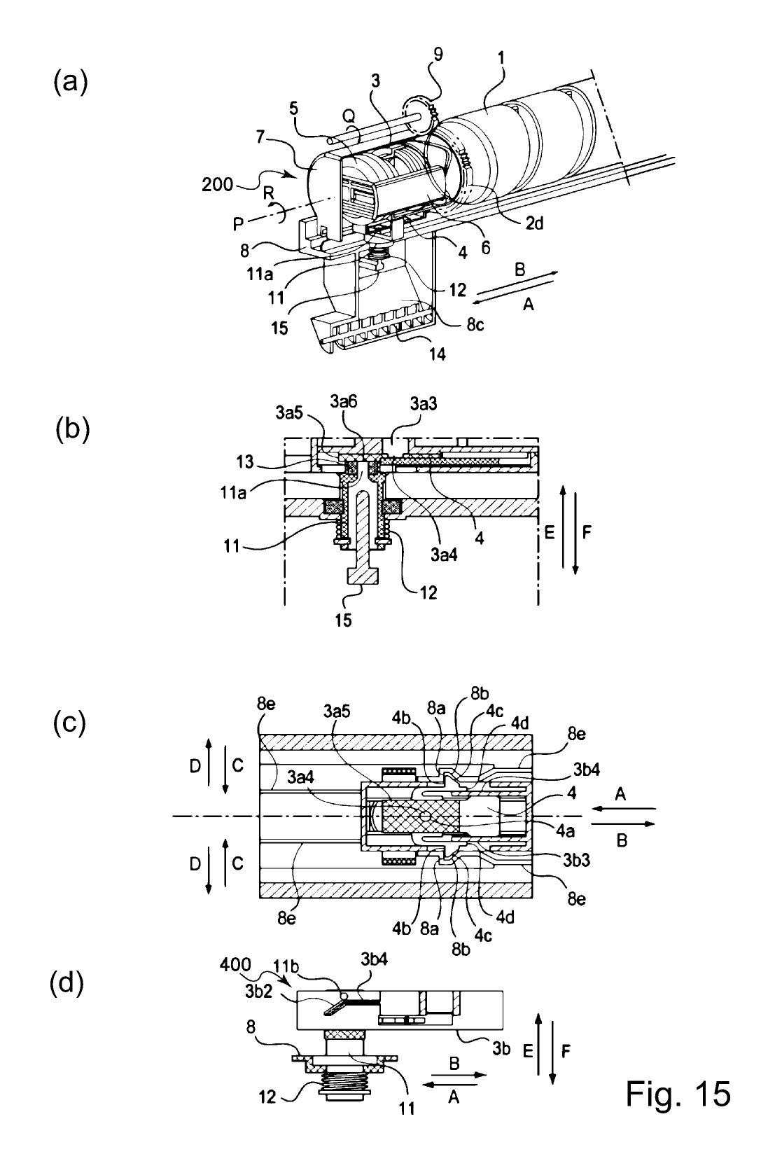

As shown in part (b) of FIG. 13, the developer receiving opening 11a is closed so as to prevent foreign matter and/or dust entering the sub-hopper 8c in a state that the developer supply container 1 is not mounted. More specifically, the developer receiving opening 11a is closed by a main assembly shutter 15 in the state that the developer receiving portion 11 is away to the upside. The developer receiving portion 11 moves upwardly (arrow E) from the position shown in part (b) of FIG. 13 toward the developer supply container 1. By this, as shown in part (b) of FIG. 15, the developer receiving opening 11a and the main assembly shutter 15 are spaced from each other so that the developer receiving opening 11a is open. With this open state, the developer is discharged from the developer supply container 1 through the discharge opening 3a4, so that the developer received by the developer receiving opening 11a is movable to the sub-hopper 8c.

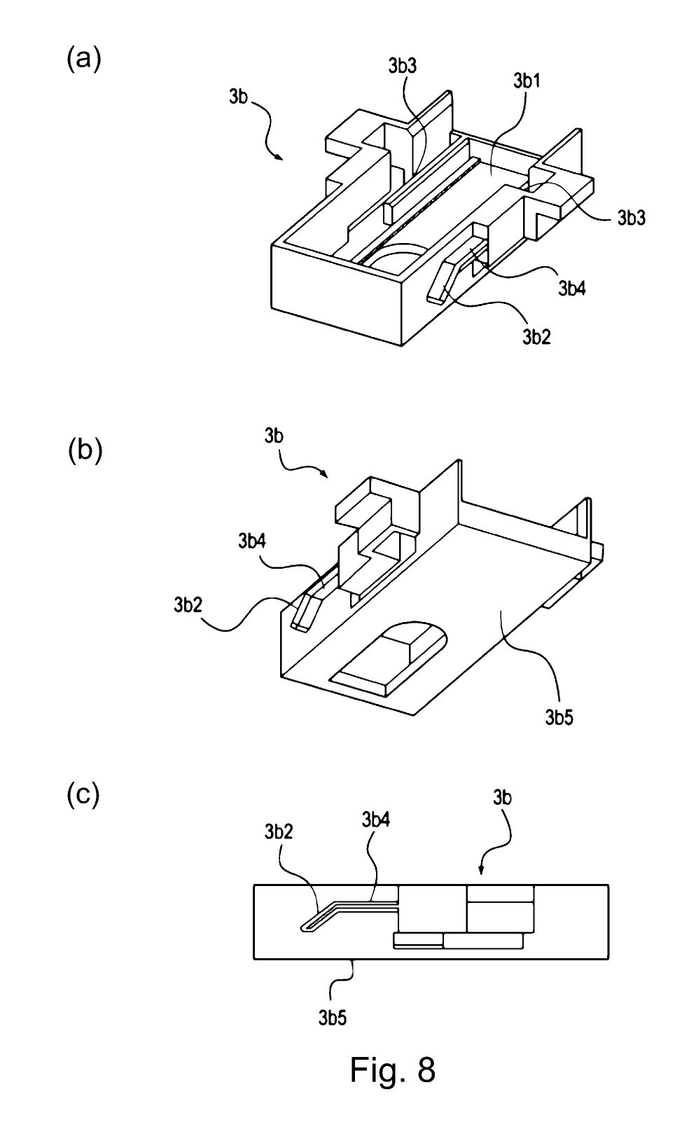

As shown in part (c) of FIG. 4, a side surface of the developer receiving portion 11 is provided with an engaging portion 11b constituting a receiving portion moving mechanism 400 as a receiving portion moving means which will be described hereinafter. The engaging portion 11b is directly engaged with guide portions 3b2, 3b4 (FIG. 8) provided on the developer supply container 1 which will be described hereinafter, and is guided thereby so that the developer receiving portion 11 is raised toward the developer supply container 1. The positional relation between the engaging portion 11b and the guide portions 3b2, 3b4 may be opposite. It will suffice if one of the developer supply container 1 and the developer receiving portion 11 is provided with the engaging portion, and the other is provided with the guide portion such that in the mounting and demounting operation of the developer supply container 1, the developer receiving portion 11 he is moved by the engagement between the engaging portion and the guide portion.

As shown in part (a) of FIG. 3, the mounting portion 8f of the developer receiving apparatus 8 is provided with an insertion guide 8e for guiding the developer supply container 1 in the mounting and demounting direction. By the insertion guide 8e, the mounting direction of the developer supply container 1 is made along the arrow A. The dismounting direction of the developer supply container 1 is the opposite (arrow B) to the direction of the arrow A.

As shown in part (a) of FIG. 3, the developer receiving apparatus 8 is provided with a driving gear 9 functioning as a driving mechanism for driving the developer supply container 1. The driving gear 9 receives a rotational force from a driving motor 500 through a driving gear train, and functions to apply a rotational force to the developer supply container 1 which is set in the mounting portion 8f. As shown in FIGS. 3 and 4, the driving motor 500 is controlled by a control device (CPU) 600.

### [Developer Supply Container]

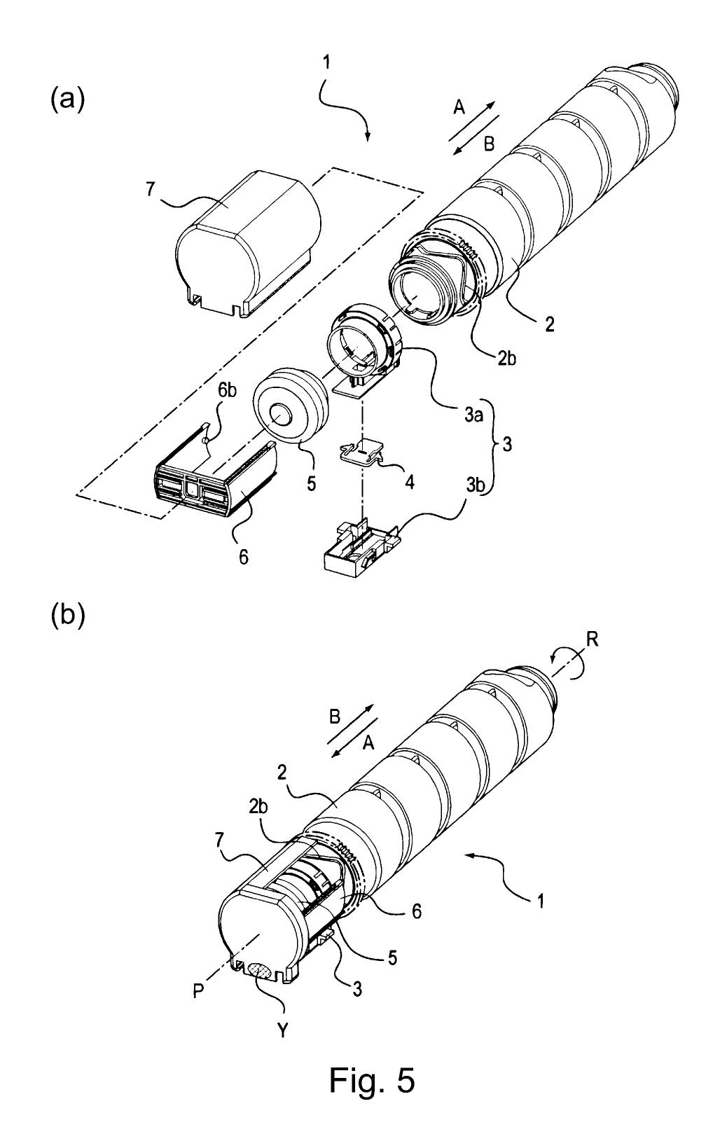

FIG. 5 to FIG. 12, the developer supply container 1 of the developer supplying apparatus 200 will be described. Referring to FIG. 5, a general arrangement of the developer supply container 1 will be described. As shown in part (a) of FIG. 5, the developer supply container 1 is detachably mountable to the main assembly 100a, and mainly comprises a container body 2, a flange portion 3, a shutter 4, a pump portion 5, a reciprocating member 6 and the cover 7. The developer supply container 1 is rotated about a rotational axis P shown in part (b) of FIG. 5 in a direction of an arrow R in the developer receiving apparatus 8, by which the developer is supplied into the developer receiving apparatus 8. Each element of the developer supply container 1 will be described in detail.

### [Container Body]

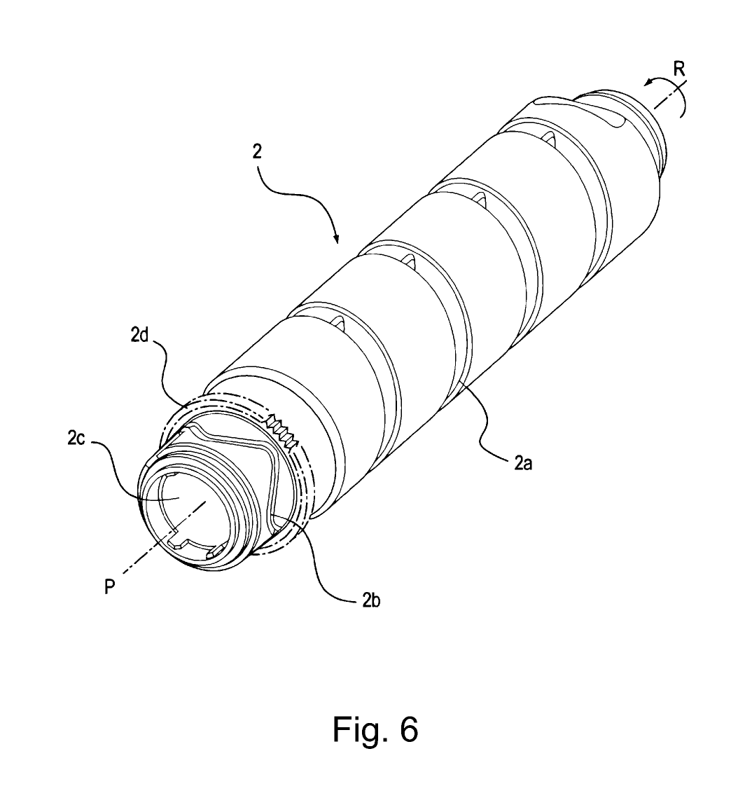

As shown in FIG. 6, the container body (developer feeding chamber) 2 mainly comprises a developer accommodating portion 2c for accommodating the developer. The container body 2 further comprises a helical feeding groove 2a (feeding portion) for feeding the developer in the developer accommodating portion 2c by rotation of the container body 2 about a rotational axis P in the direction of the arrow R. As shown in FIG. 6, a cam groove 2b and drive receiving portion (drive inputting portion) for receiving the drive from the main assembly side are formed integrally with the body 2, over the full circumference at one end portion of the container body 2. In this example, the cam groove 2b and the drive receiving portion 2d are integrally formed with the container body 2, but the cam groove 2b or the drive receiving portion 2d may be formed as another member, and may be mounted to the container body 2. In this example, the developer containing the toner having a volume average particle size of 5 μm-6 μm is accommodated in the developer accommodating portion 2c of the container body 2. In this example, the developer accommodating portion (developer accommodating space) 2c is provided not only by the container body 2 but also by the inside space of the flange portion 3 and the pump portion 5.

### [Flange Portion]

Referring to FIGS. 5, 7 and 8, the flange portion 3 will be described. As shown in part (b) of FIG. 5, the flange portion (developer discharging chamber) 3 is rotatable relative to the container body 2 about the axis P. When the developer supply container 1 is mounted to the developer receiving apparatus 8, it is not rotatable in the direction of the arrow R relative to the mounting portion 8f (part (a) of FIG. 3). In addition, it is provided with the discharge opening 3a4 (FIG. 7). As shown in part (a) of FIG. 5, the flange portion 3 is divided into an upper flange portion 3a, a lower flange portion 3b taking into account an assembling property, and the pump portion 5, the reciprocating member 6, the shutter 4 and the cover 7 are mounted thereto.

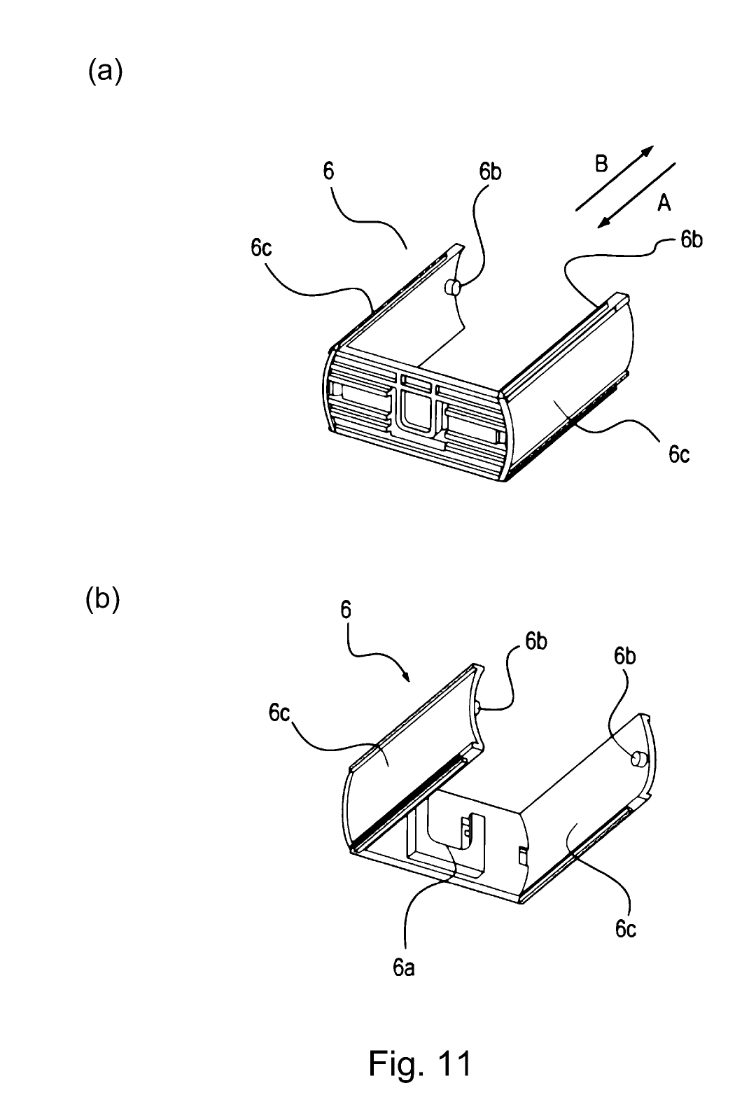

As shown in part (a) of FIG. 5, the pump portion 5 is connected with one end portion side of-the upper flange portion 3a by screws, and the container body 2 is connected with the other end portion side through a sealing member (unshown). The pump portion 5 is sandwiched between the reciprocating members 6, and engaging projections 6b (FIG. 11) of the reciprocating member 6 are fitted in the cam groove 2b of the container body 2. Furthermore, the shutter 4 is inserted into a gap between the upper flange portion 3a and the lower flange portion 3b. For protection of the reciprocating member 6 and the pump portion 5 and for better outer appearance, the cover 7 is integrally provided so as to cover the entirety of the flange portion 3, the pump portion 5 and the reciprocating member 6.

### [Upper Flange Portion]

Referring to FIG. 7, the upper flange portion 3a will be described. The upper flange portion 3a includes a pump connecting portion 3a1 (screw is not shown) to which the pump portion 5 is threaded, a container body connecting portion 3a2 shown in part (b) of FIG. 7 to which the container body 2 is connected, and a storage portion 3a2 for storing the developer fed from the container body 2. As shown in part (b) of FIG. 7, there are provided a circular discharge opening (opening) 3a4 for permitting discharging of the developer into the developer receiving apparatus 8 from the storage portion 3a3, and an opening seal 3a5 forming a connecting portion 3a6 connecting with the developer receiving portion 11 which will be described hereinafter. The opening seal 3a5 is stuck on the bottom surface of the upper flange portion 35a by a double coated tape and is nipped by shutter 4 which will be described hereinafter and the flange portion 3a to prevent leakage of the developer through the discharge opening 3a4. In this example, the discharge opening 3a4 is provided to opening seal 3a5 which is unintegral with the flange portion 3a, but the discharge opening 3a4 may be provided directly in the upper flange portion 35a.

As described above, the diameter of the discharge opening 3a4 is approx. 2 mm for the purpose of minimizing the contamination with the developer which may be unintentionally discharged by the opening and closing of the shutter 4 in the mounting and demounting operation of the developer supply container 1 relative to the developer receiving apparatus 8. In this example, the discharge opening 3a4 is provided in the lower surface of the developer supply container 1, that is, the lower surface of the upper flange portion 3a. However, the connecting structure of this example can be accomplished if it is fundamentally provided in a side except for a upstream side end surface or a downstream side end surface with respect to the mounting and dismounting direction of the developer supply container 1 relative to the developer receiving apparatus 8. The position of the discharge opening 25a4 may be properly selected taking situation of the specific apparatus into account. A connecting operation between the developer supply container 1 and the developer receiving apparatus 8 in this example will be described hereinafter.

### [Lower Flange Portion]

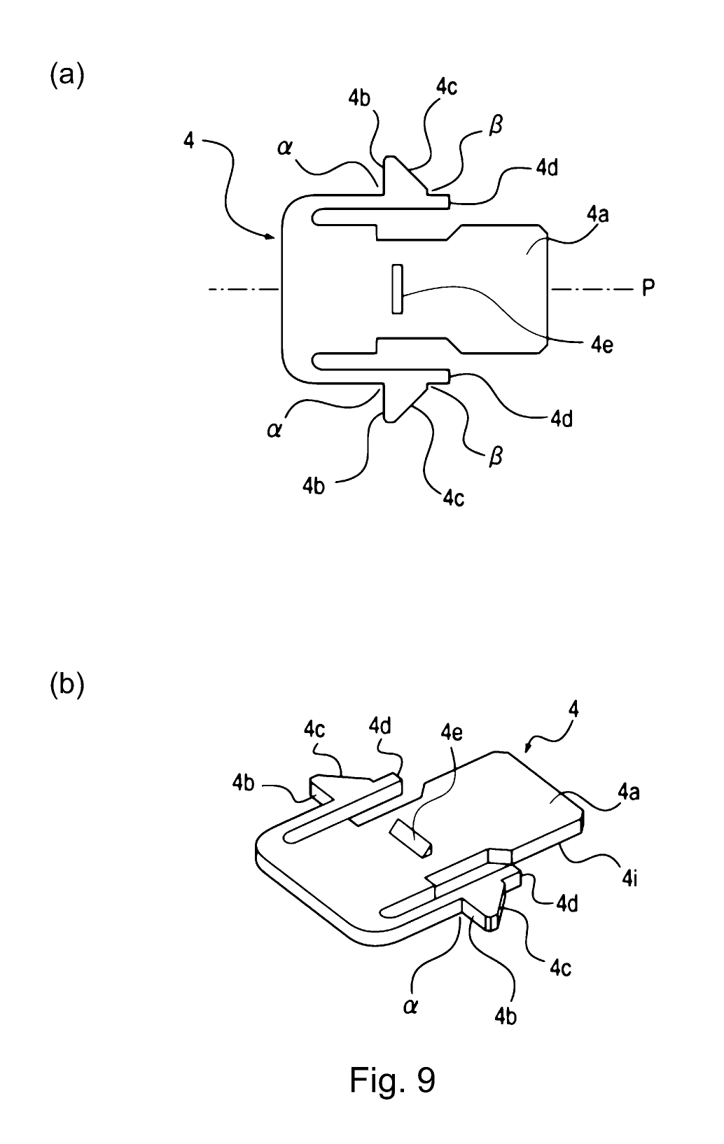

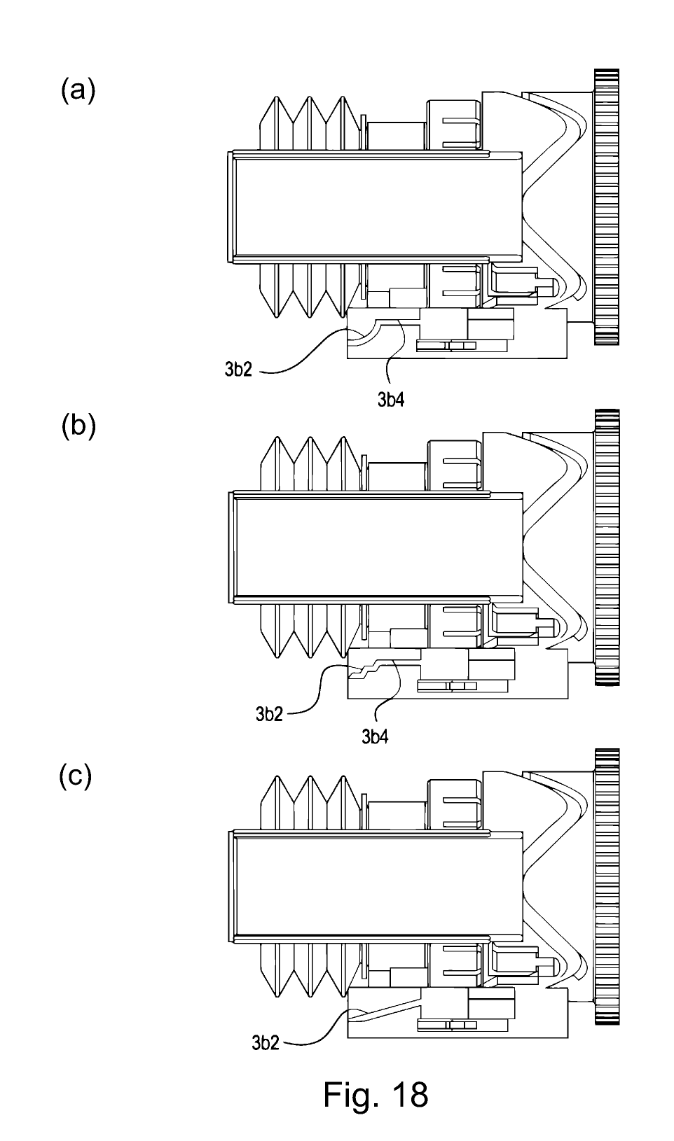

Referring to FIGS. 8 and 18, the lower flange 3b will be described. As shown in part (a) of FIG. 8, the lower flange portion 3b is provided with a shutter inserting portion 3b1 into which the shutter (FIG. 9) is inserted. The lower flange 3b constitutes the receiving portion moving mechanism 400 which will be described hereinafter, and is provided with guide portions 3b2, 3b4 engageable with the engaging portion 11b of the developer receiving portion 11 (FIG. 4).

The guiding portions 3b2, 3b4 displace the developer receiving portion 11 toward the developer supply container 1 with the mounting operation of the developer supply container 1 so that the connected state is established in which the developer supply from the developer supply container 1 to the developer receiving portion 11 is enabled. The guiding portions 3b2, 3b4 guide the developer receiving portion 11 to space away from the developer supply container 1 so that the connection between the developer supply container 1 and the developer receiving portion 39 is broken with the dismounting operation of the developer supply containerl.

A first guiding portion 3b2 of the guiding portions 3b2, 3b4 displaces the developer receiving portion 11 in the direction crossing with the mounting direction of the developer supply container 1 for permitting an unsealing operation of the developer receiving portion 1. In this example, the first guiding portion 3b2 displaces the developer receiving portion 11 toward the developer supply container 1 so that the developer receiving portion 11 is connected with the connecting portion 3a6 formed in a part of the opening seal 3a5 with the mounting operation of the developer supply container 1. The first guiding portion 3b2 extends in the direction inclining relative to the mounting direction of the developer supply container 1.

The first guiding portion 3b2 effects a guiding operation so as to displace the developer receiving portion 11 in the direction crossing with the dismounting direction of the developer supply container 1 such that the developer receiving portion 11 is resealed with the dismounting operation of the developer supply container 1. In this example, the first guiding portion 3b2 effects the guiding so that the developer receiving portion 11 is spaced away from the developer supply container 1 downwardly, so that the connection state between the developer receiving portion 11 and the connecting portion 3a6 is broken with the dismounting operation of the developer supply container 1.

On the other hand, a second engaging portion 3b4 maintains the connection stated between the opening seal 3a5 and a main assembly seal 13, so that the discharge opening 3a4 is brought into communication with a developer receiving opening 11a of the developer receiving portion 11, with the mounting operation of the developer supply container 1. During the developer supply container 1 moving relative to the shutter 4 which will be described hereinafter, that is, during the developer receiving opening 11a moving from the connecting portion 3a6 to the discharge opening 3a4, the connection between the main assembly seal 13 and the opening seal 3a5 is maintained. Such a second guide portion 3b4 extends in a direction parallel with the mounting direction of the developer supply container 1.

The second engaging portion 3b4 maintains the connection between the main assembly seal 13 and the opening seal 3a5 so that the discharge opening 3a4 is resealed, with the dismounting operation of the developer supply container 1. During the developer supply container 1 moving relative to the shutter 4, that is, during the developer receiving opening 11a moving from the discharge opening 3a4 to the connecting portion 3a6, the connection between the main assembly seal 13 and the opening seal 3a5 is maintained.

The configuration of the first guide portion 3b2 is not limited to a linear inclined surface as shown in part (a) of FIG. 8. The configuration of the first guide portion 3b2 may be curved as shown in part (a) of FIG. 18, for example. Furthermore, it may be steps-like as shown in part (b) of FIG. 18. The configuration of the first engaging portion 3b2 is not limited to the configuration shown in parts (a) or (b) of FIGS. 8 and 18, if it can displace the developer receiving portion 11 toward the discharge opening 3a4. However, a linear inclined surface is desirable from the standpoint of constant manipulating force required by the mounting and dismounting operation of the developer supply container 1. An inclination angle of the first guiding portion 3b2 relative to the mounting and dismounting direction of the developer supply container 1 is desirably approx. 10-50 degrees in view of the situation which will be described hereinafter. In this example, the angle is approx. 40 degrees. In addition, as shown in part (c) of FIG. 18, the first guiding portion 3b2 and the second guiding portion 3b4 may be unified to provide a uniformly linear inclined surface. In this case, with the mounting operation of the developer supply container 1, the first guiding portion 3b2 displaces the developer receiving portion to connect the main assembly seal 13 with the connecting portion 3a6 developer receiving portion 11 in the direction crossing with the mounting direction of the developer supply container 1. Thereafter, it displaces the developer receiving portion 11 while compressing the main assembly seal 13 and the opening seal 3a5, until the developer receiving opening 11a and the discharge opening 3a4 are brought into fluid communication with each other.

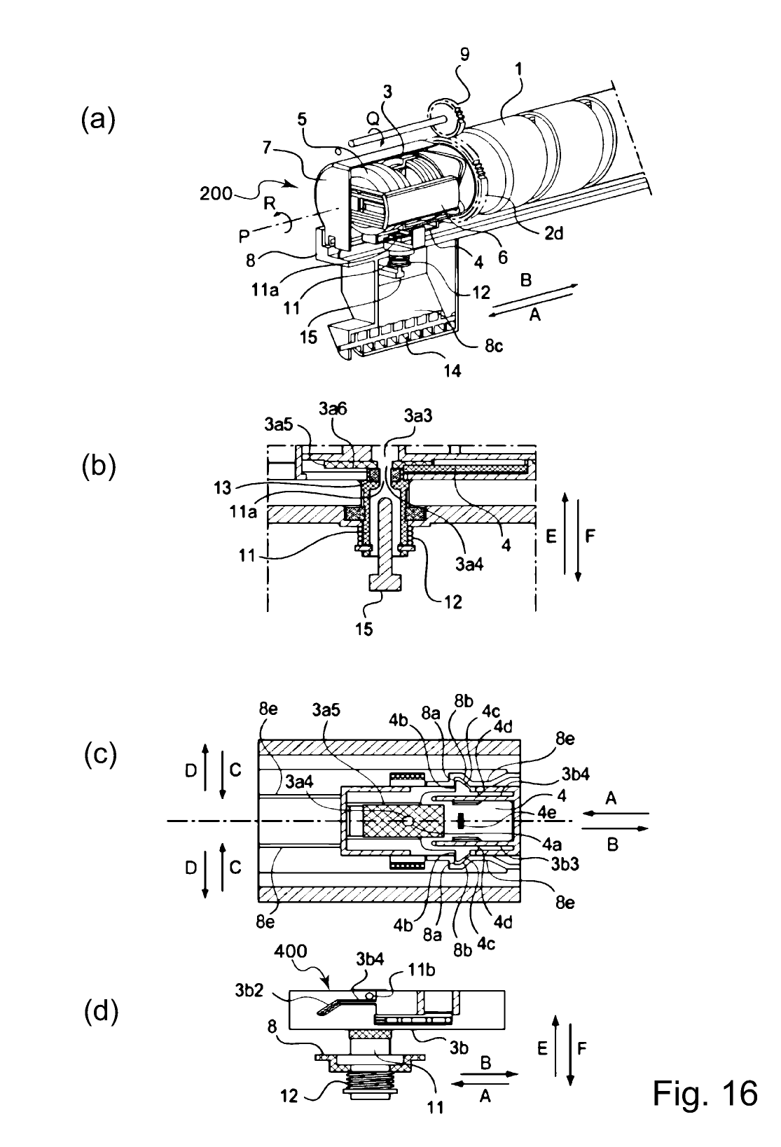

Here, when such a first guiding portion 3b2 shown in part (c) of FIG. 18 is used, the developer supply container 1 always receives a force in the direction of B (part (a) of FIG. 16) in the completed position of the mounting of the developer supply container 1 which will be described hereinafter. Therefore, the developer receiving apparatus 8 is required to have a holding mechanism for holding the developer supply container 1 in the mounting completed position, with the result of increase in cost and/or increase in the number of parts. Therefore, this standpoint, it is preferable that the developer supply container 1 is provided with the above-described second engaging portion 3b4 so that the force in the B direction is not applied to the developer supply container 1 in the mounting completed position. By this, the connection state is stably maintained between the main assembly seal 13 and the opening seal 3a5.

The first guiding portion 3b2 shown in part (c) of FIG. 18 has a linear inclined surface, but similar to the part (a) of FIG. 18 or part (b) of FIG. 18, for example, a curved or stepped configuration is usable. However, the linear inclined surface is preferable from the standpoint of constant manipulating force in the mounting and dismounting operations of the developer supply container 1, as described hereinbefore.

The lower flange portion 3b is provided with a regulation rib (regulating portion) 3b3 (part (a) of FIG. 3) for preventing or permitting an elastic deformation of a supporting portion 4d of the shutter 4 which will be described hereinafter, with the mounting or dismounting operation of the developer supply container 1 relative to the developer receiving apparatus 8. The regulation rib 3b3 protrudes upwardly from an insertion surface of the shutter inserting portion 3b1 and extends along the mounting direction of the developer supply container 1. In addition, as shown in part (b) of FIG. 8, the protecting portion 3b5 is provided to protect the shutter 4 from damage during transportation and/or mishandling of the operator. The lower flange portion 3b is integral with the upper flange portion 3a in the state that the shutter 4 is inserted in the shutter inserting portion 3b1.

### [Shutter]

Referring to FIG. 9, the shutter 4 will be described. The shutter 4 is movable relative to the developer supply container 1 to open and close the discharge opening 3a4 with the mounting operation and the dismounting operation of the developer supply container 1. The shutter 4 is provided with a developer sealing portion 4a and a sliding surface 4i. The developer sealing portion 4a prevents leakage of the developer through the discharge opening 3a4 when the developer supply container 1 is not mounted to the mounting portion 8f of the developer receiving apparatus 8. The sliding surface 4i is provided on a rear side of the developer sealing portion 4a, and slides on the shutter inserting portion 3b1 of the lower flange 3b.

The shutter 4 is provided with a stopper portion (holding portion) 4b, 4c held by shutter stopper portions 8n, 8p (part (a) of FIG. 4) of the developer receiving apparatus 8 with the mounting and dismounting operations of the developer supply container 1 so that the developer supply container 1 moves relative to the shutter 4. A first stopper portion 5b of the stopper portions 4b, 4c engages with a first shutter stopper portion 8n of the developer receiving apparatus 8 to fix the position of the shutter 4 relative to the developer receiving apparatus 8 at the time of mounting operation of the developer supply container 1. A second stopper portion 4c engages with a second shutter stopper portion 8b of the developer receiving apparatus 8 at the time of the dismounting operation of the developer supply container 1.

The shutter 4 is provided with a supporting portion 4d so that the stopper portions 4b, 4c are displaceable. The supporting portion 4d extends from the developer sealing portion 4a and is elastically deformable to displaceably support the first stopper portion 4b and the second stopper portion 4c. The first stopper portion 4b is inclined such that an angle α formed between the first stopper portion 4b and the supporting portion 4d is acute. On the contrary, the second stopper portion 4c is inclined such that an angle β formed between the second stopper portion 4c and the supporting portion 4d is obtuse.

The developer sealing portion 4a of the shutter 4 is provided with a locking projection 4e at a position downstream of the position opposing the discharge opening 3a4 with respect to the mounting direction when the developer supply container 1 is not mounted to the mounting portion 8f of the developer receiving apparatus 8. A contact amount of the locking projection 4e relative to the opening seal 3a5 (part (b) of FIG. 7) is larger than relative to the developer sealing portion 4a so that a static friction force between the shutter 4 and the opening seal 3a5 is large. Therefore, an unexpected movement (displacement) of the shutter 4 due to a vibration during the transportation or the like can be prevented. The entirety of the developer sealing portion 4a may correspond to the contact amount between the locking projection 4e and the opening seal 3a5, However, in such a case, the dynamic friction force relative to the opening seal 3a5 at the time when the shutter 4 moves is large as compared with the case of the locking projection 4e provided. Therefore, a manipulating force required when the developer supply container 1 is mounted to the developer replenishing apparatus 8 is large, which is not preferable from the standpoint of the usability. Therefore, it is desired to provide the locking projection 4e in a part as in this example.

### [Pump Portion]

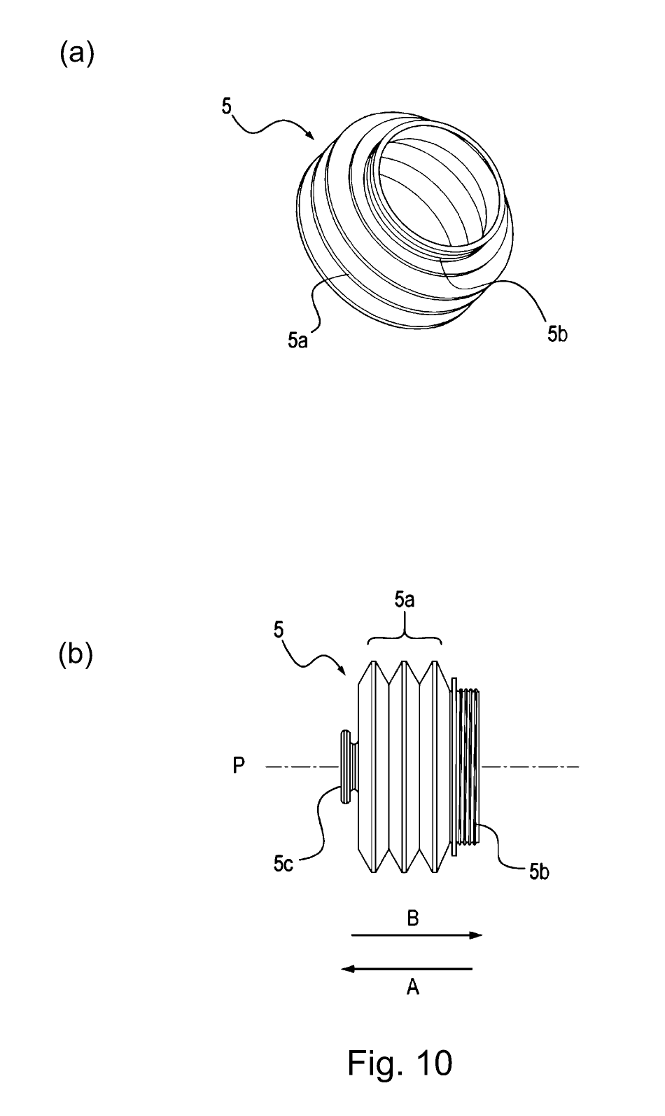

Referring to FIG. 10, the pump portion 5 will be described. The pump portion 5 is operated by the driving force received by the drive receiving portion (drive inputting portion) 2d so as to alternately produce a state in which the internal pressure of the developer accommodating portion 2c is lower than the ambient pressure and a state in which it is higher than the ambient pressure. In this example, the pump portion 5 is provided as a part of the developer supply container 1 in order to discharge the developer stably from the small discharge opening 3a4. The pump portion 5 is a displacement type pump in which the volume changes. More specifically, the pump includes a bellow-like expansion-and-contraction member.

By the expanding-and-contracting operation of the pump portion 5, the pressure in the developer supply container 1 is changed, and the developer is discharged using the pressure. More specifically, when the pump portion 5 is contracted, the inside of the developer supply container 1 is pressurized so that the developer is discharged through the discharge opening 3a4. When the pump portion 5 expands, the inside of the developer supply container 1 is depressurized so that the air is taken in through the discharge opening 3a4 from the outside. By the take-in air, the developer in the neighborhood of the discharge opening 3a4 and/or the storage portion 3a3 is loosened so as to make the subsequent discharging smooth. By repeating the expanding-and-contracting operation described above, the developer is discharged.

As shown in part (b) of FIG. 10, the pump portion 5 of this modified example has the bellow-like expansion-and-contraction portion (bellow portion, expansion-and-contraction member) 5a in which the crests and bottoms are periodically provided. The expansion-and-contraction portion 5a expands and contracts in the directions of arrows A and B. When the bellow-like pump portion 5 as in this example, a variation in the volume change amount relative to the amount of expansion and contraction can be reduced, and therefore, a stable volume change can be accomplished.

In addition, in this example, the material of the pump portion 2 is polypropylene resin material (PP), but this is not inevitable. The material of the pump portion 5 may be any if it can provide the expansion and contraction function and can change the internal pressure of the developer accommodating portion by the volume change. The examples includes thin formed ABS (acrylonitrile, butadiene, styrene copolymer resin material), polystyrene, polyester, polyethylene materials. Alternatively, other expandable-and-contractable materials such as rubber are usable.

In addition, as shown in part (a) of FIG. 10, the opening end side of the pump portion 5 is provided with a connecting portion 5b connectable with the upper flange portion 3a. Here, the connecting portion 5b is a screw. Furthermore, as shown in part (b) of FIG. 10 the other end portion side is provided with a reciprocating member engaging portion 5c engaged with the reciprocating member 5 to displace in synchronism with the reciprocating member 6 which will be described hereinafter.

### [Reciprocating Member]

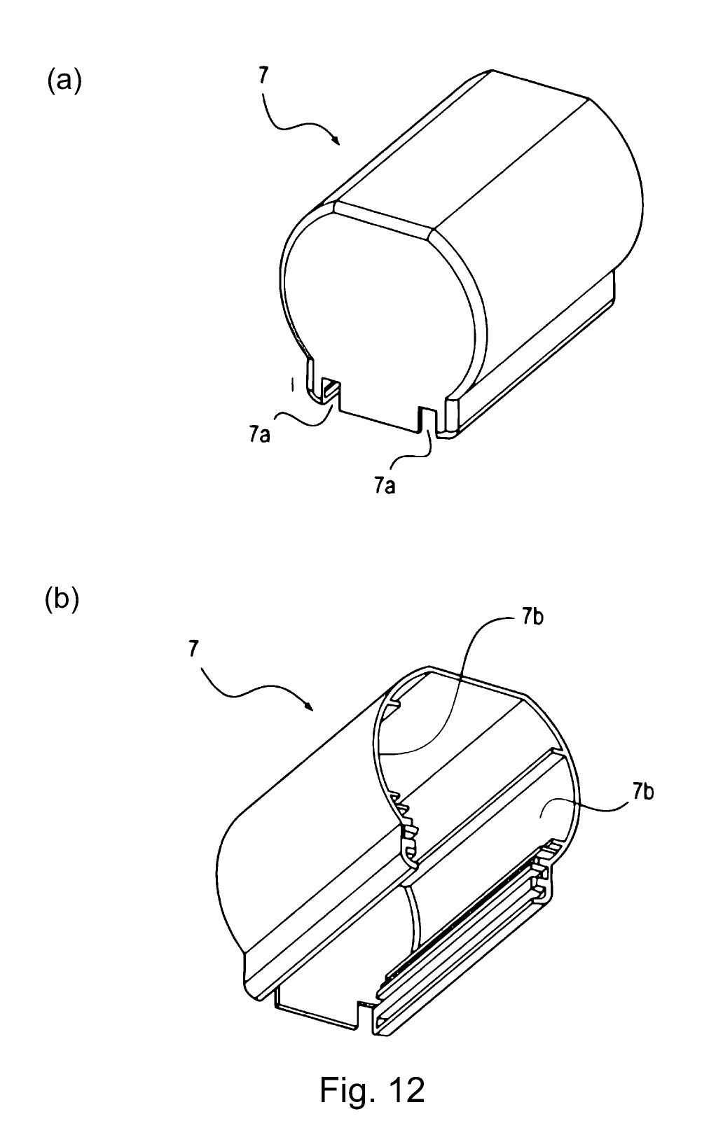

Referring to FIG. 11, the reciprocating member 6 will be described. As shown in part (b) of FIG. 11, the reciprocating member 6 is provided with a pump engaging portion 6a engaged with the reciprocating member engaging portion 5c provided on the pump portion 5 to change the volume of the pump portion 5 as described above. Furthermore, as shown in part (a) and part (b) of FIG. 11 the reciprocating member 6 is provided with the engaging projection 6b fitted in the above-described cam groove 2b (FIG. 5) when the container is assembled. The engaging projection 6b is provided at a free end portion of the arm 6c extending from a neighborhood of the pump engaging portion 6a. Rotation displacement of the reciprocating member 6 about the axis P (part (b) of FIG. 5) of the arm 6c is prevented by a reciprocating member holding portion 7b (FIG. 12) of the cover 7 which will be described hereinafter. Therefore, when the container body 2 receives the drive from the drive receiving portion 2d and is rotated integrally with the cam groove 20n by the driving gear 9, the reciprocating member 6 reciprocates in the directions of arrows An and B by the function of the engaging projection 6b fitted in the cam groove 2b and the reciprocating member holding portion 7b of the cover 7. Together with this operation, the pump portion 5 engaged through the pump engaging portion 6a of the reciprocating member 6 and the reciprocating member engaging portion 5c expands and contracts in the directions of arrows An and B.

### [Cover]

Referring to FIGS. 5 and 12, the cover 7 will be described. The cover 7 is provided as shown in part (b) of FIG. 5 in order to protect the reciprocating member 38 and/or the pump portion 2 and to improve the outer appearance. In more detail, as shown in part (b) of FIG. 5, the cover 7 is provided integrally with the upper flange portion 3a and/or the lower flange portion 3b and so on by a mechanism (unshown) so as to cover the entirety of the flange portion 3, the pump portion 5 and the reciprocating member 6. In addition, the cover 7 is provided with a guide groove 7a to be guided by the insertion guide 8e (part (a) of FIG. 3) of the developer receiving apparatus 8. In addition, the cover 7 is provided with a reciprocating member holding portion 7b for regulating a rotation displacement about the axis P (part (b) of FIG. 5) of the reciprocating member 6 as described above.

### [Mounting Operation of Developer Supply Container]

Referring to FIGS. 13, 14, 15, 16 and 17, the mounting operation of the developer supply container 1 to the developer receiving apparatus 8 will be described in detail. Parts (a)-(c) of FIG. 13-FIG. 16 show the neighborhood of the connecting portion between the developer supply container 1 and the developer receiving apparatus 8. Parts (d) of FIG. 13 to FIG. 16 illustrate particularly the relationship between the lower flange 3b and the developer receiving portion 11. The mounting operation is the operation until the developer becomes able to be supplied to the developer receiving apparatus 8 from the developer supply container 1.

FIG. 13 shows a connection starting position (first step) of the developer supply container 1 to the developer receiving apparatus 8. As shown in part (a) of FIG. 13, the developer supply container 1 is inserted into the developer receiving apparatus 8 in the direction indicated by the arrow A. First, as shown in part (c) of FIG. 13, the first stopper portion 4b of the shutter 4 contacts the first shutter stopper portion 8a of developer receiving apparatus 8, so that the position of the shutter 4 relative to the developer receiving apparatus 8 is fixed. In this state, the relative position between the lower flange portion 3b and the upper flange portion 3a of the flange portion 3 and the shutter 4 remains unchanged, and therefore, the discharge opening 3a4 is sealed assuredly by the developer sealing portion 4a of the shutter 4. As shown in part (b) of FIG. 13, the connecting portion 3a6 of the opening seal 3a5 is shielded by the shutter 4.

As shown in part (c) of FIG. 13, the supporting portion 4d of the shutter 4 is displaceable in the direction of arrows C and D, since the regulation rib 3b3 of the lower flange portion 3b does not enter the supporting portion 4d. As has been described above, the first stopper portion 4b is inclined such that the angle α (part (a) of FIG. 9) relative to the supporting portion 4d is acute, and the first shutter stopper portion 8a is also inclined, correspondingly. In this example, the inclination angle α is approx. 80 degrees. Therefore, when the developer supply container 1 is inserted further in the arrow A direction, the first stopper portion 4b receives a reaction force in the arrow B direction from the first shutter stopper portion 8a, so that the supporting portion 4d is displaced in an arrow D direction. That is, the first stopper portion 4b of the shutter 4 displaces in the direction of holding the engagement state with the first shutter stopper portion 8a of the developer receiving apparatus 8, and therefore, the position of the shutter 4 is held assuredly relative to the developer receiving apparatus 8.

In addition, as shown in part (d) of FIG. 13, the positional relation between the engaging portion 11b of the developer receiving portion 11 and the first engaging portion 3b2 of the lower flange portion 3b is such that they start engagement with each other. Therefore, the developer receiving portion 11 remains in the initial position in which it is spaced from the developer supply container 1. More specifically, as shown in part (b) of FIG. 13, the developer receiving portion 11 is spaced from the connecting portion 3a6 formed on a part of the opening seal 3a5. As shown in part (b) of FIG. 13, the developer receiving opening 11a is in the sealed state by the main assembly shutter 15. In addition, the driving gear 9 of the developer receiving apparatus 8 and the drive receiving portion 2d of the developer supply container 1 are not connected with each other, that is, in the non-transmission state.

In this example, the distance between the developer receiving portion 11 and the developer supply container 1 is approx. 2 mm. When the distance is too small, not more than approx. 1.5 mm, for example, the developer deposited on the surface of the main assembly seal 13 provided on the developer receiving portion 11 may be scattered by air flow produced locally by the mounting and dismounting operation of the developer supply container 1. The scattered developer may be deposited on the lower surface of the developer supply container 1. On the other hand, the distance is too large, a stroke required to displace the developer receiving portion 11 from the spacing position to the connected position is large with the result of upsizing of the image forming apparatus. Or, the inclination angle of the first guiding portion 3b2 of the lower flange portion 3b is steep relative to the mounting and dismounting direction of the developer supply container 1 with the result of increase of the load required to displace the developer receiving portion 11. Therefore, the distance between the developer supply container 1 and the developer receiving portion 11 is properly determined taking the specifications of the main assembly or the like into account. As described above, in this example, the inclination angle of the first guiding portion 3b2 relative to the mounting and dismounting direction of the developer supply container 1 is approx. 40 degrees. The same applies to the following embodiments.

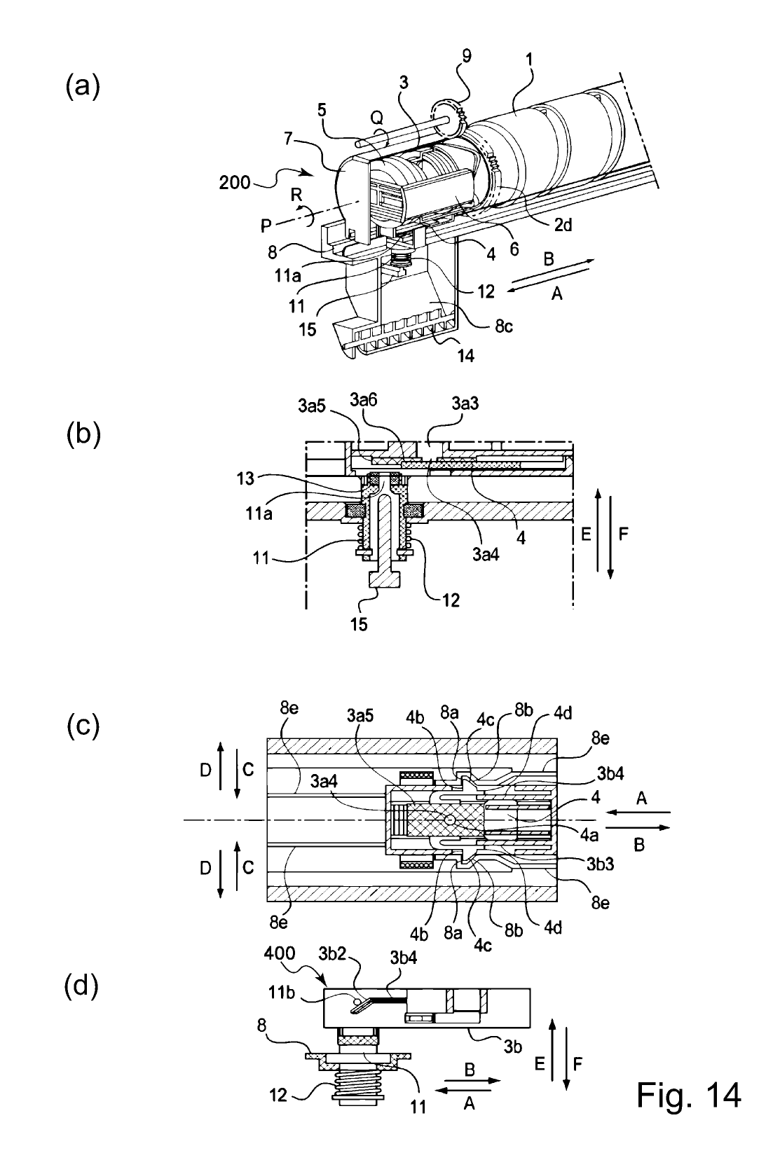

Then, as shown in part (a) of FIG. 14, the developer supply container 1 is further inserted in the direction of the arrow A (second step). As shown in part (c) of FIG. 14, the developer supply container 1 moves relative to the shutter 4 in the direction of the arrow A, since the position of the shutter 4 is held relative to the developer receiving apparatus 8. At this time, as shown in part (b) of FIG. 14, a part of the connecting portion 3a6 of the opening seal 3a5 is exposed through the shutter 4. Further, as shown in part (d) of FIG. 14, the first guiding portion 3b2 of the lower flange portion 3b directly engages with the engaging portion 11b of the developer receiving portion 11 so that the engaging portion 11b is displaced in the direction of the arrow E by the first guiding portion 3b2. Therefore, the developer receiving portion 11 is displaced in the direction of the arrow E against the urging force of the urging member 12 (arrow F) to the position shown in part (b) of FIG. 14, so that the developer receiving opening 11a is spaced from the main assembly shutter 15, thus starting to unseal. Here, in the position of FIG. 14, the developer receiving opening 11a and the connecting portion 3a6 are spaced from each other. Further, as shown in part (c) of FIG. 14, the regulation rib 3b3 of the lower flange portion 3b enters of supporting portion 4d of the shutter 4, so that the supporting portion 4d can not displace in the direction of arrow C or arrow D. That is, the elastic deformation of the supporting portion 4d is limited by the regulation rib 3b3.

Then, as shown in part (a) of FIG. 15, the developer supply container 1 is further inserted in the direction of the arrow A (third step). Then, as shown in part (c) of FIG. 15, the developer supply container 1 moves relative to the shutter 4 in the direction of the arrow A, since the position of the shutter 4 is held relative to the developer receiving apparatus 8. At this time, the connecting portion 3a6 formed on the part of the opening seal 3a5 is completely exposed from the shutter 4. In addition, the discharge opening 3a4 is not exposed from the shutter 4, so that it is still sealed by the developer sealing portion 4a.

Furthermore, as described hereinbefore, the regulation rib 3b3 of the lower flange portion 3b enters the supporting portion 4d of the shutter 4, by which the supporting portion 4d can not displace in the direction of arrow C or arrow D. At this time, as shown in part (d) of FIG. 15, the directly engaged guiding portion 11b of the developer receiving portion 11 reaches the upper end side of the first engaging portion 3b2. The developer receiving portion 11 is displaced in the direction of the arrow E against the urging force (arrow F) of the urging member 12, to the position shown in part (b) of FIG. 15, so that the developer receiving opening 11a is completely spaced from the main assembly shutter 15 to be unsealed.

At this time, the connection is established in the state that the main assembly seal 13 having the developer receiving opening 11a is close-contacted to the connecting portion 3a6 of the opening seal 3a5. In other words, by the developer receiving portion 11 directly engaging with the first engaging portion 3b2 of the developer supply container 1, the developer supply container 1 can be accessed by the developer receiving portion 11 from the lower side in the vertical direction which is crossed with the mounting direction. Thus, the above-described the structure can avoid the developer contamination at the end surface Y (part (b) of FIG. 5) in the downstream side with respect to the mounting direction of the developer supply container 1, the developer contamination having been produced in the conventional structure in which the developer receiving portion 11 accesses the developer supply container 1 in the mounting direction. The conventional structure will be described hereinafter.

Subsequently, as shown in part (a) of FIG. 16, when the developer supply container 1 is further inserted in the direction of the arrow A to the developer receiving apparatus 8 (fourth step). Then, as shown in part (c) of FIG. 16, the developer supply container 1 moves relative to the shutter 4 in the direction of the arrow A similar to the forgoing, up to a supply position (second position). In this position, the driving gear 9 and the drive receiving portion 2d are connected with each other, and by the driving gear 9 rotating in the direction of an arrow Q, the container body 2 is rotated in the direction of the arrow R. As a result, the pump portion 5 is reciprocated by the reciprocation of the reciprocating member 6 in interrelation with the rotation of the container body 2. Therefore, the developer in the developer accommodating portion 2c is supplied into the sub-hopper 8c from the storage portion 3a3 through the discharge opening 3a4 and the developer receiving opening 11a by the reciprocation of the pump portion 5 described above.

In addition, as shown in part (d) of FIG. 16, when the developer supply container 1 reaches the supply position relative to the developer receiving apparatus 8, the engaging portion 11b of the developer receiving portion 11 is engaged with the second guiding portion 3b4 by way of the engaging relation with the first engaging portion 3b2 of the lower flange portion 3b. And, the engaging portion 11b is brought into the state of being urged to the second guiding portion 3b4 by the urging force of the urging member 12 in the direction of the arrow F. Therefore, the position of the developer receiving portion 11 in the vertical direction is stably maintained. Furthermore, as shown in part (b) of FIG. 16, the discharge opening 3a4 is unsealed by the shutter 4, and the discharge opening 3a4 and the developer receiving opening 11a are brought into fluid communication with each other.

At this time, the developer receiving opening 11a slides on the opening seal 3a5 to communicate with the discharge opening 3a4 while keeping the close-contact state between the main assembly seal 13 and the connecting portion 3a6 formed on the opening seal 3a5. Therefore, the amount of the developer falling from the discharge opening 3a4 and scattering to the position other than the developer receiving opening 11a is small. Thus, the contamination of the developer receiving apparatus 8 by the scattering of the developer is less.

### [Dismounting Operation of Developer Supply Container]

Referring mainly to FIG. 13-FIGS. 16 and 17, the operation of dismounting of the developer supply container 1 from the developer receiving apparatus 8 will be described. The dismounting operation of the developer supply container 1 is a reciprocal of the above-described mounting operation. Thus, the developer supply container 1 is dismounted from the developer receiving apparatus 8 in the order from FIG. 16 to FIG. 13. The dismounting operation (removing operation) is the operation to the state in which the developer supply container 1 can be take out of the developer receiving apparatus 8.

The amount of the developer in the developer supply container 1 placed in the supply position shown in FIG. 16 decreases, a message promoting exchange of the developer supply container 1 is displayed on the display (unshown) provided in the image forming apparatus 100 (FIG. 1). The operator prepares a new developer supply container 1 opens the exchange cover 40 provided in the image forming apparatus 100 shown in FIG. 2, and extracts the developer supply container 1 in the direction of the arrow B shown in part (a) of FIG. 16.

In this process, as described hereinbefore, the supporting portion 4d of the shutter 4 can not displace in the direction of arrow C or arrow D by the limitation of the regulation rib 3b3 of the lower flange portion 3b. Therefore, FIG. 16, when the developer supply container 1 tends to move in the direction of the arrow B with the dismounting operation, the second stopper portion 4c of the shutter 4 abuts to the second shutter stopper portion 8b of the developer receiving apparatus 8, so that the shutter 4 does not displace in the direction of the arrow B. In other words, the developer supply container 1 moves relative to the shutter 4.

Thereafter, when the developer supply container 1 is drawn to the position shown in FIG. 15, the shutter 4 seals the discharge opening 3a4 as shown in part (b) of FIG. 15. Further, as shown in part (d) of FIG. 15, the engaging portion 11b of the developer receiving portion 11 displaces to the downstream lateral edge of the first guiding portion 3b2 from the second guiding portion 3b4 of the lower flange portion 3b with respect to the dismounting direction. As shown in part (b) of FIG. 15, the main assembly seal 13 of the developer receiving portion 11 slides on the opening seal 3a5 from the discharge opening 3a4 of the opening seal 3a5 to the connecting portion 3a6, and maintains the connection state with the connecting portion 3a6.

Similarly to the foregoing, as shown in part (c) of FIG. 15, the supporting portion 4d is in engagement with the regulation rib 3b3, so that it can not displace in the direction of the arrow B in the Figure. Thus, when the developer supply container 1 is taken out from the position of FIG. 15 to the position of FIG. 13, the developer supply container 1 moves relative to the shutter 4, since the shutter 4 can not displace relative to the developer receiving apparatus 8.

Subsequently, the developer supply container 1 is drawn from the developer receiving apparatus 8 to the position shown in part (a) of FIG. 14. Then, as shown in part (d) of FIG. 14, the engaging portion 11b slides down on the first guiding portion 3b2 to the position of the generally middle point of the first guiding portion 3b2 by the urging force of the urging member 12. Therefore, the main assembly seal 13 provided on the developer receiving portion 11 downwardly spaces from the connecting portion 3a6 of the opening seal 3a5, thus releasing the connection between the developer receiving portion 11 and the developer supply container 1. At this time, the developer is deposited substantially on the connecting portion 3a6 of the opening seal 3a5 with which the developer receiving portion 11 has been connected.

Subsequently, the developer supply container 1 is drawn from the developer receiving apparatus 8 to the position shown in part (a) of FIG. 13. Then, as shown in part (d) of FIG. 13, the engaging portion 11b slides down on the first guiding portion 3b2 to reach the upstream lateral edge with respect to dismounting direction of the first guiding portion 3b2, by the urging force of the urging member 12. Therefore, the developer receiving opening 11a of the developer receiving portion 11 released from the developer supply container 1 is sealed by the main assembly shutter 15. By this, it is avoided that foreign matter or the like enters through the developer receiving opening 11a and that the developer in the sub-hopper 8c (FIG. 4) scatters from the developer receiving opening 11a. The shutter 4 displaces to the connecting portion 3a6 of the opening seal 3a5 with which the main assembly seal 13 of the developer receiving portion 11 has been connected to shield the connecting portion 3a6 on which the developer is deposited.

Further, with the above-described dismounting operation of the developer supply container 1, the developer receiving portion 11 is guided by the first guiding portion 3b2, and the spacing operation from the developer supply container 1 is completed. Thereafter, as shown in part (c) of FIG. 13, the supporting portion 4d of the shutter 4 is disengaged from the regulation rib 3b3 so as to become elastically deformable. The configurations of the regulation rib 3b3 and/or the supporting portion 4d are properly selected so that the position where the engaging relation is released is substantially the same as the position where the shutter 4 enters when developer supply container 1 is not mounted to the developer receiving apparatus 8. Therefore, when the developer supply container 1 is further drawn in the direction of the arrow B shown in part (a) of FIG. 13, the second stopper portion 4c of the shutter 4 abuts to the second shutter stopper portion 8b of the developer receiving apparatus 8, as shown in part (c) of FIG. 13. By this, the second stopper portion 4c of the shutter 4 displaces (elastically deforms) in the direction of arrow C along a taper surface of the second shutter stopper portion 8b, so that the shutter 4 becomes displaceable in the direction of the arrow B relative to the developer receiving apparatus 8 together with the developer supply container 1. That is, when the developer supply container 1 is taken out of the developer receiving apparatus 8, the shutter 4 returns to the position taken when the developer supply container 1 is not mounted to the developer receiving apparatus 8. Therefore, the discharge opening 3a4 is assuredly sealed by the shutter 4, and therefore, the developer is not scattered from the developer supply container 1 demounted from the developer receiving apparatus 8. Even if the developer supply container 1 is mounted to the developer receiving apparatus 8, again, it can be mountable without any problem.

As described in the foregoing, according to this example, the mechanism for connecting and spacing the developer receiving portion 11 relative to the developer supply container 1 by displacement of the developer receiving portion 11 can be simplified. More particularly, a driving source and/or a drive transmission mechanism for moving the entirety of the developing device upwardly is unnecessary, and therefore, a complication of the structure of the image forming apparatus side and/or the increase in cost due to increase of the number of parts can be avoided.

In a conventional structure, a large space is required to avoid an interference with the developing device in the upward and downward movement, but according to this example, such a large space is unnecessary so that the upsizing of the image forming apparatus can be avoided.

The connection between the developer supply container 1 and the developer receiving apparatus 8 can be properly established using the mounting operation of the developer supply container 1 with minimum contamination with the developer. Similarly, utilizing the dismounting operation of the developer supply container 1, the spacing and resealing between the developer supply container 1 and the developer receiving apparatus 8 can be carried out with minimum contamination with the developer.

The developer supply container 1 of this example can cause the developer receiving portion 11 to move in the direction crossing with the mounting direction of developer supply container 1, using the guiding portions 3b2, 3b4 of the lower flange portion 3b with the mounting and demounting operation to the developer receiving apparatus 8. Also, it is possible to connect the developer receiving opening 11a upwardly with the discharge opening 3a4 and disconnect the developer receiving opening 11a from the discharge opening 3a4 downwardly. The developer receiving portion 11 is sufficiently small relative to developer supply container 1, and therefore, the developer contamination of the downstream side end surface Y (part (b) of FIG. 5) of the developer supply container 1 with respect to the mounting direction, with the simple and space saving structure. In addition, the developer contamination by the main assembly seal 13 slides on the protecting portion 3b5 of the lower flange portion 3b and the sliding surface (lower surface of the shutter) 4i.

Furthermore, after the developer receiving portion 11 is connected to the developer supply container 1 with the mounting operation of the developer supply container 1 to the developer receiving apparatus 8, the discharge opening 3a4 is exposed from the shutter 4 so that the discharge opening 3a4 and the developer receiving port 11a can be brought into communication with each other. In other words, the timing of each step is controlled by the guiding portions 3b2, 3b4 of the developer supply container 1, and therefore, the scattering of the developer can be suppressed assuredly with a simple and easy structure, without the being influenced by the way of operation by the operator.

In addition, after the discharge opening 3a4 is sealed and the developer receiving portion 11 is spaced from the developer supply container 1 with the dismounting operation of the developer supply container 1 from the developer receiving apparatus 8, the shutter 4 can shield the developer deposition portion of the opening seal 3a5. In other words, the timing of each step in the dismounting operation can be controlled by the guiding portions 3b2 and 3b4 of the developer supply container 1, and therefore, the scattering of the developer can be suppressed, and the developer deposition portion can be prevented from the exposing to the outside.

In the prior-art structure, the connection relation between the connecting portion and the connected portion is established indirectly through another mechanism, and therefore, it is difficulty to control the connection relation with high precision.

However, in this example, the connection relation can be established by the directly engagement between the connecting portion (developer receiving portion 11) and the connected portion (developer supply container 1). More specifically, the timing of the connection between the developer receiving portion 11 and the developer supply container 1 can be controlled easily by the positional relation, in the mounting direction, among the engaging portion 11b, the first and second guiding portions 3b2 and 3a4 of the lower flange portion 3b and discharge opening 3a4. In other words, the timing may deviate within the tolerances of the three elements, and therefore, very high accuracy control can be performed. Therefore, the connecting operation of the developer receiving portion 11 to the developer supply container 1 and the spacing operation from the developer supply container 1 can be carried out assuredly, with the mounting operation and the dismounting operation of the developer supply container 1.

Regarding the displacement amount of the developer receiving portion 11 in the direction crossing with the mounting direction of the developer supply container 1 can be controlled by the positions of the engaging portion 11b of the developer receiving portion 11 and the second engaging portion 3b4 of the lower flange portion 3b. Similarly to the foregoing, the deviation of the displacement amount may deviate within the tolerances of the two elements, and therefore, very high accuracy control can be performed. Therefore, for example, close-contact state (amount of sealing compression or the like) between the main assembly seal 13 and the discharge opening 3a4 can be controlled easily, so that the developer discharged from the discharge opening 3a4 can be fed into the developer receiving opening 11a assuredly.

### First Embodiment

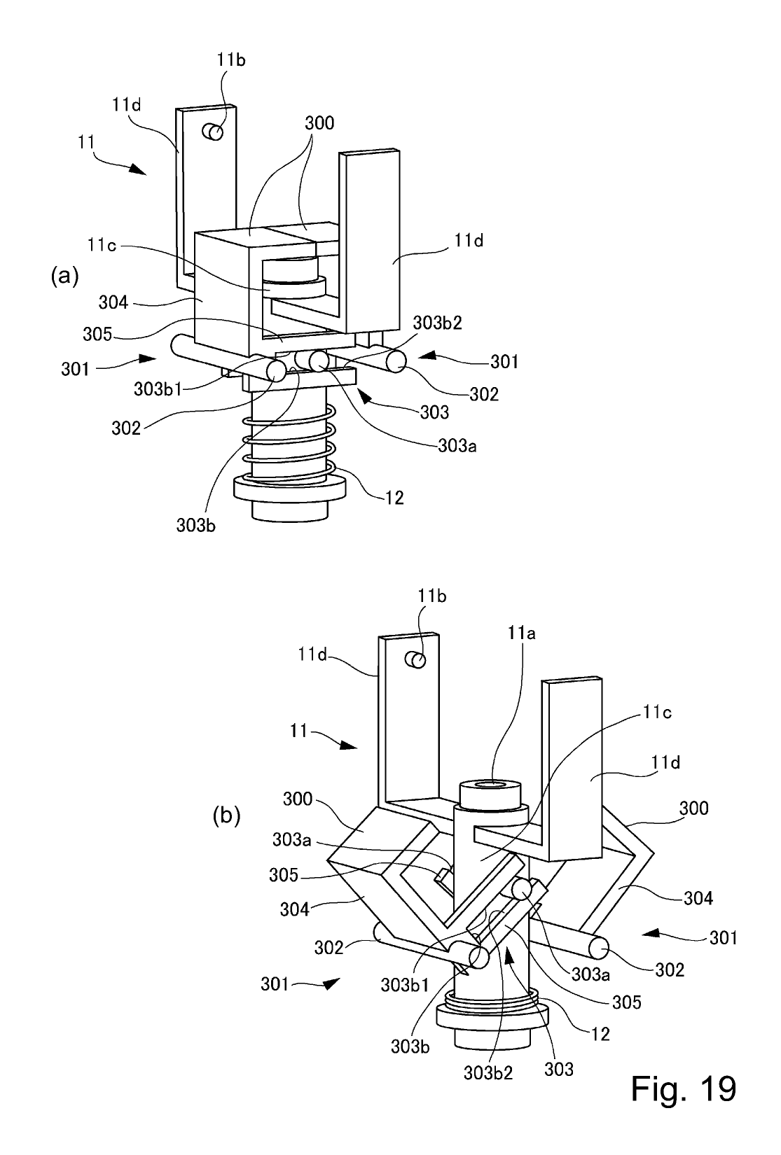

Referring to FIG. 19, a developer supplying apparatus 200 provided with the above-described developer receiving portion 11 and developer supply container 1 according to a first embodiment will be described. In the case of this embodiment, there is provided a covering member 300 movable between a covering position (part (a) of FIG. 19) covering the developer receiving opening 11a of the developer receiving portion 11 and an open position (part (b) of FIG. 19) opening the developer receiving opening 11a. The covering member 300 comprises plate-like members, and covers a part above the developer receiving opening 11a, that is, a developer supply container 1 side, when taking the covering position. On the other hand, in a retracted position, the covering member 300 is retracted from the upper position to permit connection of the developer receiving opening 11a with the discharge opening 3a4 of the developer supply container 1.

To accomplish this, the covering member 300 is moved in interrelation with the movement of the developer receiving portion 11 by a covering member moving mechanism 301 as a covering member moving means. That is, in interrelation with the movement of the developer receiving portion 11 moved in accordance with the mounting operation of the developer supply container 1, the covering member moving mechanism 301 moves the covering member 300 from the covering position to the open position. In this embodiment, a pair of such covering members 300 opposed to each other is moved by the covering member moving mechanism 301. The developer receiving opening 11a is covered by them contacting at the free end portions.

The developer receiving portion 11 comprises a main body portion 11c, a pair of arm portions 11d and engaging portions 11b provided projected adjacent to the free end portions of the arm portions 11d. The arm portions 11d are faced to each other at upper positions of the main body portion 11c, and is extended up beyond than developer receiving opening 11a. The covering members 300 are provided at positions away from the arm portions 11d, and therefore, are movable between the covering position and the open position without interference with the arm portions 11d. The covering member 300 may be constituted by a single plate or by three or more plates.

When the developer supply container 1 is not mounted to the developer receiving portion 11, the covering member moving mechanism 301 places the covering member 300 in the covering position. On the other hand, when the developer receiving opening 11a is connected to the discharge opening 3a4 of the developer supply container 1, the covering members 300 take the open position. The covering member moving mechanism 301 operates in interrelation with the movement of the developer receiving portion 11. To accomplish this, in this embodiment, the covering member moving mechanism 301 comprises a rotational shaft 302 and a rotating portion 303.

Is rotational shaft 302 rotatably supports the covering members 300 between the covering position and the open position. In this embodiment, the rotational shaft 302 is rotatably mounted on a fixed portion of the developer receiving apparatus 8, and therefore, it is not movable in the moving direction of the developer receiving portion 11. The rotating portion 303 imparts a relative movement between the covering member 300 and the developer receiving portion 11 with the movement of the developer receiving portion 11, and rotates the covering member 300 about the rotational shaft 302.

The rotation portion 303 includes an engaging projection 303a, an engaging groove 303b having engagement surface portions 303b1, 303b2 as portion-to-be-engaged (engaged portion). The engaging projection 303a is provided on the main body portion 11c and projects in parallel with the rotational shaft 302. In this embodiment, the engaging projection 303a has a cylindrical outer peripheral surface projected at a middle portion with respect to the moving direction of the developer receiving portion 11. Therefore, the engaging projection 303a moves together with developer receiving portion 11. The engaging groove 303b is provided in the covering member 300, and is engaged by the engaging projection 303a, and with the movement of the developer receiving portion 11, the engaging projection 303a makes a relative movement to rotate the covering members 300 about the rotational shaft 302.

The rotating portion 303 includes a connection plate portion 304 extended from a base end portion of the covering member 300 toward the rotational shaft 302, and an engagement plate portion 305 extended from the connection plate portion 304 in the direction along the covering member 300. The covering members 300, the connection plate portion 304 and the engagement plate portion 305 are integral with each other, and the rotational shaft 302 is fixed to a position where the connection plate portion 304 and the engagement plate portion 305 connect with each other. The engagement plate portion 305 extends perpendicularly to the rotational shaft 302 and is disposed at a position not interfering with the developer receiving portion 11.

The engaging groove 303b is formed by cutting the engagement plate portion 305 from the free end portion thereof to the base end portion of the rotational shaft 302. Thus, the end portion of the engaging groove 303b opposite from the rotational shaft 302 is open so as to receive the engaging projection 303a. The opposing surfaces of the engaging groove 303b are engagement surface portions 303b1, 303b2. The gap between the engagement surface portions 303b1, 303b2 is slightly larger than an outer diameter of the cylindrical engaging projection 303a to permit movement of the engaging projection 303a in the engaging groove 303b.

The covering members 300 rotated by the covering member moving mechanism 301 do not interfere with the developer supply container 1. That is, the covering members 300 and the rotational shaft 302 are disposed such that when the developer supply container 1 is mounted to the developer receiving apparatus 8 or when it is taken out of the developer receiving apparatus 8, the covering members 300 or the shaft 302 does not interfere with the developer supply container 1.

The operation of the covering members 300 of the developer supplying apparatus 200 will be described. First, the description will be made as to the state in which the developer supply container 1 is not mounted to the developer receiving portion 11. In such a state, the developer receiving opening 11a is spaced from the discharge opening 3a4, and the covering members 300 cover the developer receiving opening 11a, as shown in part (a) of FIG. 19. In this state, the developer receiving opening 11a is covered by the covering members 300, and therefore, entrance of the foreign matter through the developer receiving opening 11a which opens upwardly can be significantly effectively. As a result, the foreign matter in the developing device 201 can be reduced, and the image defect can be decreased.

The description will be made as to the operation at the time when the developer supply container 1 is mounted to the developer receiving portion 11. When the developer supply container 1 is mounted, the operator inserts the developer supply container 1 into the developer receiving apparatus 8, by which the bottom end portion of the developer supply container 1 passes by the upper portion of the developer receiving opening 11a. At this time, the movement of the developer receiving portion 11 does not start yet, and therefore, the covering members 300 remain covering the developer receiving opening 11a. Therefore, even if the foreign matter, if any, that is deposited on the developer supply container 1 fall, it does not or hardly enter through the developer receiving opening 11a into the developer supply container 1. In addition, the covering member 300 does not contact to the developer supply container 1, and therefore, the contamination of the developer supply container 1 is not directly transferred onto the covering member 300.

Subsequently, when the developer supply container 1 is inserted further into the developer receiving apparatus 8 the first guide portion 3b2 of the developer supply container 1 shown in FIGS. 13, 14 engages with the engaging portion 11b of the developer receiving portion 11 to start lifting the developer receiving portion 11. When it starts, the engaging projection 303a slides while being in engagement with the engagement surface portion 303b1 of the engaging groove 303b to rotate the covering member 300 about the rotational shaft 302. At this time, the covering members 300 rotate to retract away from the developer receiving opening 11a and does not blocks the movement of the developer receiving portion 11. In addition, the covering members 300 do not contact to the developer supply container 1 even during the rotation, and therefore, does not block the movement of the developer supply container 1, and in addition, the contamination of the developer supply container 1 is not directly transferred.

As shown in FIGS. 15, 16, when the developer supply container 1 is mounted to the developer receiving apparatus 8 and the developer receiving opening 11a close-contacts the opening seal 3a5 of the developer supply container 1, the covering members 300 are in the open state as shown in part (b) of FIG. 19. That is, in a state that the engaging portion 11b is engaged with the second guide portion 3b4 as a result of mounting of the developer supply container 1 to the developer receiving apparatus 8, the developer receiving opening 11a is close-contacted to the opening seal 3a5. By further insertion of the developer supply container 1, the discharge opening 3a4 is connected to the developer receiving opening 11a. At this time, the covering members 300 stop at positions retracted from the developer receiving opening 11a, and therefore, they do not obstruct the connection between the developer receiving portion 11 and the developer supply container 1.

Thus, the covering members 300 are rotated in interrelation with the movement of the developer receiving portion 11, and therefore, they do not rotate before the start of the raising of the developer receiving portion 11. In other words, until the start of the connection of the developer receiving portion 11, the entrance of the foreign matter through the developer receiving opening 11a can be prevented effectively.

The operation at the time when the developer supply container 1 is dismounted from the developer receiving portion 11 will be described. When the developer supply container 1 is dismounted, the operator removes the developer supply container 1 from the developer receiving apparatus 8. When the removal of the developer supply container 1 starts, the second guide portion 3b4 is disengaged from the engaging portion 11b, and thereafter, the developer supply container 1 starts removal from the developer receiving portion 11. In the removal of the developer receiving portion 11, the engaging projection 303a slides along the engagement surface portion 303b2 of the engaging groove 303b, so that the covering member 300s tarts to rotate about the rotational shaft 302 in the covering direction. That is, the rotation of the covering member 300 in the covering direction for the developer receiving opening 11a also starts.

When the removal of the developer receiving portion 11 is completed, the developer receiving opening 11a is covered by the covering member 300. At this time, the covering member 300 does not contact to the developer supply container 1, and therefore, the contamination of the developer supply container 1 is not directly transferred. Since the removing operation of the developer supply container 1 continues then, it is possible that the foreign matter may fall, but the developer receiving opening 11a is covered by the covering member 300, and therefore, the entrance of the foreign matter into the developer receiving opening 11a can be prevented effectively.

In this manner, in this embodiment, the developer receiving opening 11a is covered by the covering member 300 in interrelation with the movement of the developer receiving portion 11, and is kept covered when the developer supply container 1 is not mounted to the developer receiving portion 11. Specifically, until the start of the movement of the developer receiving portion 11 with the mounting operation of the developer supply container 1, the covering member 300 covers the developer receiving opening 11a. When the movement of the developer receiving portion 11 wherein the dismounting operation of the developer supply container 1 starts, the covering member 300 rotates in the direction of covering the developer receiving opening 11a, and after the completion of the movement of the developer receiving portion 11, the developer receiving opening 11a is covered by the covering member 300.

On the other hand, when the developer receiving opening 11a contacts with the discharge opening 3a4, the covering member 300 opens the developer receiving opening 11a. In other words, wherein the structure of covering the developer receiving opening 11a by the covering member 300, the connection of the developer receiving opening 11a with the discharge opening 3a4 is enabled by the rotation of the covering member 300 in the direction retracting from the developer receiving opening 11a with the movement of the developer receiving portion 11.

Therefore, the entrance of the foreign matter into the developer receiving opening 11a can be suppressed by the structure in which the developer receiving opening 11a is connected with the discharge opening 3a4 of the developer supply container 1 by moving the developer receiving portion 11 having the developer receiving opening 11a for receiving the developer.

In this embodiment, the covering member moving mechanism 301 for operating the covering member 300 is operated in interrelation with the movement of the developer receiving portion 11. Therefore, it is unnecessary to employ an additional driving source for opening and locking the opening by the covering member 300. The operation of the covering member 300 is mechanically interrelated with the movement of the developer receiving portion 11. Therefore, when the developer receiving opening 11a is connected with the discharge opening 3a4, the covering member 300 is assuredly in the open state, and when the developer supply container 1 is not mounted to the developer receiving portion 11, the covering member 300 is assuredly in the covering state.

In the foregoing description, the rotational shaft 302 is fixed to the fixed portion of the developer receiving apparatus 8, and it slides relative to the engaging projection 303a in the engaging groove 303b integral with the covering member 300, so that the covering member 300 is rotated in interrelation with the movement of the developer receiving portion 11. However, the mechanism for rotating the covering member 300 in interrelation with the movement of the developer receiving portion 11 is not restricted to the structure. For example, a rotational shaft is provided on the developer receiving portion 11, and the covering member 300 is rotatable about the rotational shaft, wherein the covering member 300 is provided at the position of the developer receiving apparatus 8 so as to be rotatable in interrelation with the movement of the developer receiving portion 11.

### Second Embodiment

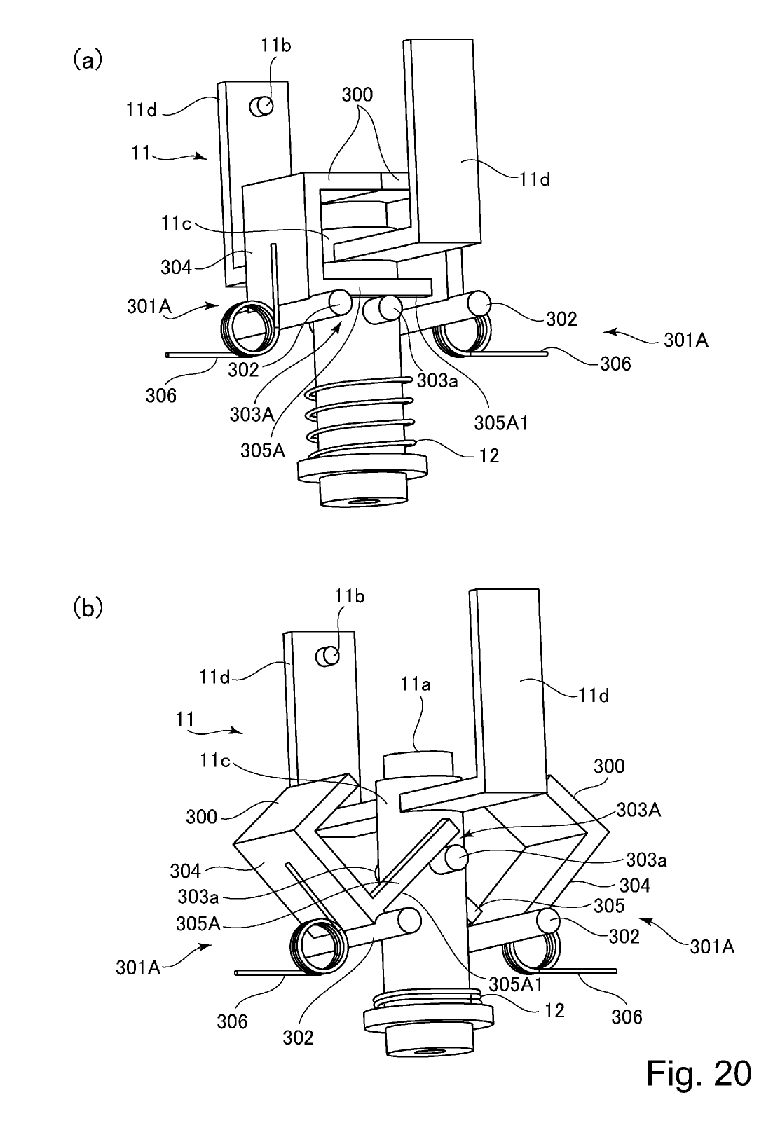

Referring to FIG. 20, a second embodiment will be described, in which the present invention is embodied in the developer supplying apparatus 200 provided with the above-described developer receiving portion 11 and developer supply container 1. In this embodiment, a spring 306 for urging the covering member 300 in the covering direction is provided. The other structures and functions are fundamentally the same as with the first embodiment, and therefore, in the description of this embodiment, the same reference numerals as in Embodiment 1 are assigned to the elements having the corresponding functions in this embodiment, and the detailed description thereof is omitted for simplicity.

The covering member moving mechanism 301A as the covering member moving means of this embodiment includes a spring 306 as an urging means for urging the covering member 300 toward the covering position.

Specifically, the spring 306 is provided between a connection plate portion 304 integral with the covering member 300 and a fixed portion of the developer receiving apparatus 8, and the covering member 300 is rotationally urged toward the covering position. In the illustrated example, the spring 306 is a twisted coil spring which applies the urging force to rotate the covering member 300.

In addition, the rotation portion 303A of this embodiment includes a connection plate portion 304 extended from the base end portion of the covering member 300 toward a rotational shaft 302 and includes an engagement plate portion 305A extended from the connection plate portion 304 along the covering member 300. In the case of this embodiment, the engagement plate portion 305A is not provided with the engaging groove as in the first embodiment. In place thereof, one side surface of the engagement plate portion 305A is used as an engagement surface portion 305A1 as a portion-to-be-engaged, and is contacted to an engaging projection 303a. The engagement surface portion 305A1 is disposed in a side where the developer receiving portion 11 moves to the discharge opening 3a4 relative to the engaging projection 303a, more particularly, in an upper side in the illustrated example.

In this embodiment, with this structure, when the developer supply container 1 is mounted to the developer receiving apparatus 8, the developer receiving portion 11 is raised in interrelation with the mounting operation, so that the engaging projection 303a slides along the engagement surface portion 305A1. By this, the covering member 300 rotates toward the open position (part (b) of FIG. 20) about the rotational shaft 302 against the urging force of the spring 306.

On the other hand, when the developer supply container 1 is removed from the developer receiving apparatus 8, the developer receiving portion 11 moves in the direction away from the developer supply container 1 in interrelation with the removing operation, and the engaging projection 303a moves in the direction of disengaging from the engagement surface portion 305A1. At this time, since the covering member 300 is urged toward the covering position (part (a) of FIG. 20) by the spring 306, the covering member 300 rotates toward the covering position about the rotational shaft 302 by the urging force of the spring 306.

In this embodiment, the spring 306 urges the covering member 300 in the covering direction, and therefore, it is unnecessary to engage the engaging projection 303a in an engaging groove 303b. That is, the engaging projection 303a is the engagement surface portion 305A1 which is one side surface of the engagement plate portion 305A. However, the engaging projection 303a in this embodiment may be engaged with the engaging groove 303b similarly to the first embodiment.

Furthermore, the covering member 300 may be urged toward the open position by a spring. However, with such a structure, the engagement surface portion of the covering member 300 side which is engaged with the engaging projection 303a is disposed in a side where the developer receiving portion 11 removes from the discharge opening 3a4 relative to the engaging projection 303a, more specifically, in the lower side in the illustrated example. By this, when the developer receiving apparatus 8 is mounted to the developer supply container 1, the developer receiving portion 11 is raised in interrelation with the mounting operation, and the engaging projection 303a moves in the direction of disengaging from the engagement surface portion. Then, the covering member 300 is moved toward the open position by the urging force of the spring. On the other hand, when the developer supply container 1 is removed from the developer receiving apparatus 8, the developer receiving portion 11 moves in the direction of disengaging from the developer supply container 1 in interrelation with the dismounting operation, and the engaging projection 303a slides along the engagement surface portion. Then, the covering member 300 rotates toward the covering position against the urging force of the spring.

### Third Embodiment

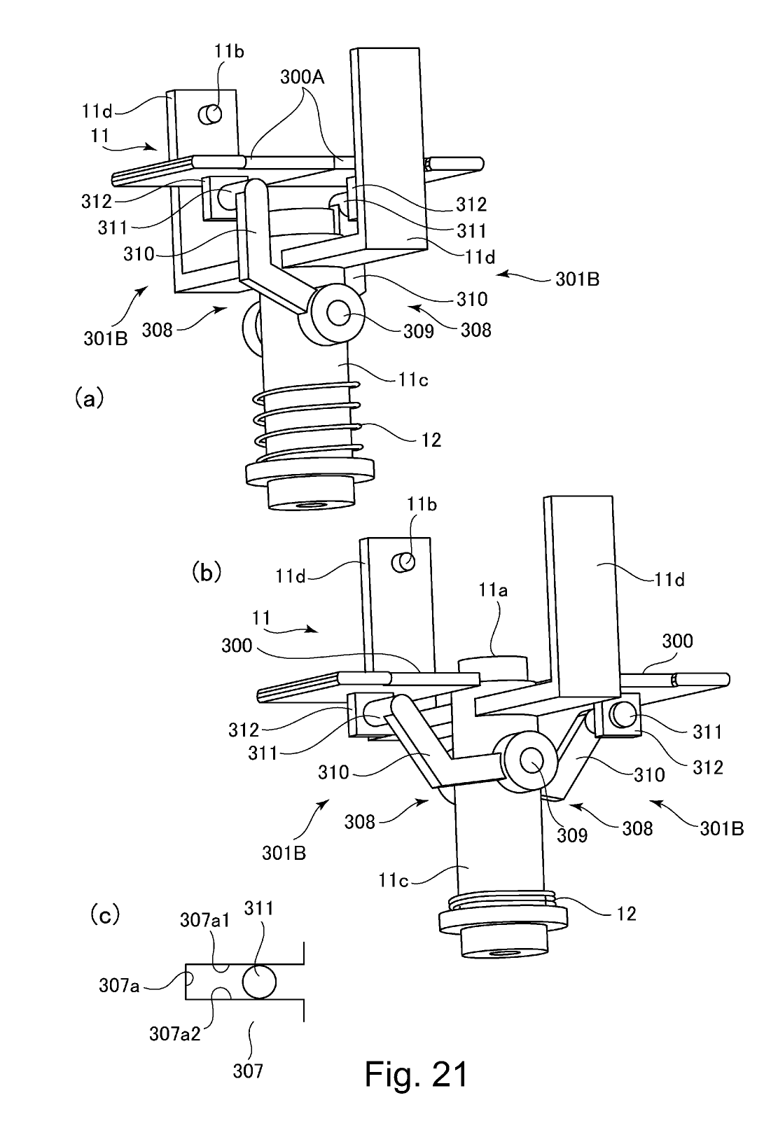

Referring to FIG. 21, a third embodiment will be described, in which the present invention is embodied in a developer supplying apparatus 200 provided with the above-described developer receiving portion 11 and developer supply container 1. In this embodiment, a covering member moving mechanism 301B as a covering member moving means slides the covering member 300A between a covering position and an open position in a direction crossing with a moving direction of the developer receiving portion 11 in interrelation with the movement of the developer receiving portion 11. To accomplish this, in this embodiment, the covering member moving mechanism 301B includes a slide guiding portion 307 and a sliding operation portion 308. The other structures and functions are fundamentally the same as with the first embodiment, and therefore, in the description of this embodiment, the same reference numerals as in Embodiment 1 are assigned to the elements having the corresponding functions in this embodiment, and the detailed description thereof is omitted for simplicity.

The sliding operation portion 308 imparts a relative movement between the covering member 300A and the developer receiving portion 11 with the movement of the developer receiving portion 11, and moves the covering member 300A along the slide guiding portion 307. The sliding operation portion 308 includes a first shaft 309, a swingable arm 310 and a second shaft 311. The first shaft 309 is provided on the main body portion 11c of the developer receiving portion 11, extending in the direction perpendicular to a moving direction of the developer receiving portion 11 and to an guiding direction (sliding direction) of the slide guiding portion 307. The swingable arm 310 is swingably supported by the first shaft 309 at one end portion. The second shaft 311 rotatably supports the other end portion of the swingable arm 310 on the covering member 300A. The covering member 300A is provided with an integral shaft receiving portion 312 for rotatably supporting the second shaft 311 six to the other end portion of the swingable arm 310. In other words, the covering member 300A is supported by the other end portion of the swingable arm 310 through the second shaft 311 and the shaft receiving portion 312.

The slide guiding portion 307 is provided at a fixed portion of the developer receiving apparatus 8, and guides the sliding motion of the covering member 300A between the covering position (part (a) of FIG. 21) and the open position (part (b) of FIG. 21) in the direction (sliding direction) crossing with the moving direction of the developer receiving portion 11. As shown in part (c) of FIG. 21, the slide guiding portion 307 is provided with a guide groove 307a for guiding the second shaft 311 rotatably supported by the shaft receiving portion 312 of covering member 300A in the sliding direction. That is, the guide groove 307a is defined by guiding surfaces 307a1, 307a2 facing each other along the moving direction developer receiving portion 11. The gap between the guiding surfaces 307a1, 307a2 is slightly larger than an outer diameter of the second shaft 311 to permit the relative movement of the second shaft 311 in the guide groove 307a.

In the case of this embodiment, with such a structure, when the developer supply container 1 is mounted to the developer receiving apparatus 8, the developer receiving portion 11 is raised in interrelation with the mounting operation, and one end portion of the swingable arm 310 supported by the first shaft 309 starts to move. Then, the second shaft 311 fixed to the other end portion of the swingable arm 310 slides while it is in engagement with the guiding surface 307a1 of the guide groove 307a, and the swingable arm 310 rotates about the first shaft 309 in such a direction that the other end portion is away from the developer receiving portion 11. At this time, since the second shaft 311 is guided by the guide groove 307a, the covering member 300A also moves in the direction away from the developer receiving portion 11 together with the second shaft 311, that is, toward the open position. The second shaft 311 moves while rotating in the guide groove 307a by the rotation of the swingable arm 310, but it is rotatable relative to the covering member 300A by the shaft receiving portion 312. Therefore, the attitude of the covering member 300A does not change despite the rotation of the second shaft 311, and moves along the sliding direction.

On the other hand, when the developer supply container 1 is dismounted from the developer receiving apparatus 8, the developer receiving portion 11 moves in the direction of dismounting from the developer supply container 1 in interrelation with the dismounting operation, and the one end portion of the swingable arm 310 supported by the first shaft 309 starts to move in the same direction. Then, the swingable arm 310 rotates about the first shaft 309 in such a direction that the other end portion moves toward the developer receiving portion 11, while the second shaft 311 fixed to the other end portion of the swingable arm 310 is in engagement with the guiding surface 307a2 of the guide groove 307a. At this time, since the second shaft 311 is guided by the guide groove 307a, the covering member 300A supported by the second shaft 311 through the shaft receiving portion 312 moves toward the developer receiving portion 11 together with the second shaft 311, that is, toward the covering position.

In the case of this embodiment, the covering member 300A slides in the direction crossing with the moving direction of the developer receiving portion 11 by the sliding operation portion 308, and therefore, the interference with the developer supply container 1 can be further avoided. The structure of the sliding operation portion 308 is not restricted to the above-described example. For example, the covering member 300A per se may be guided by a slide guiding portion.

### Fourth Embodiment

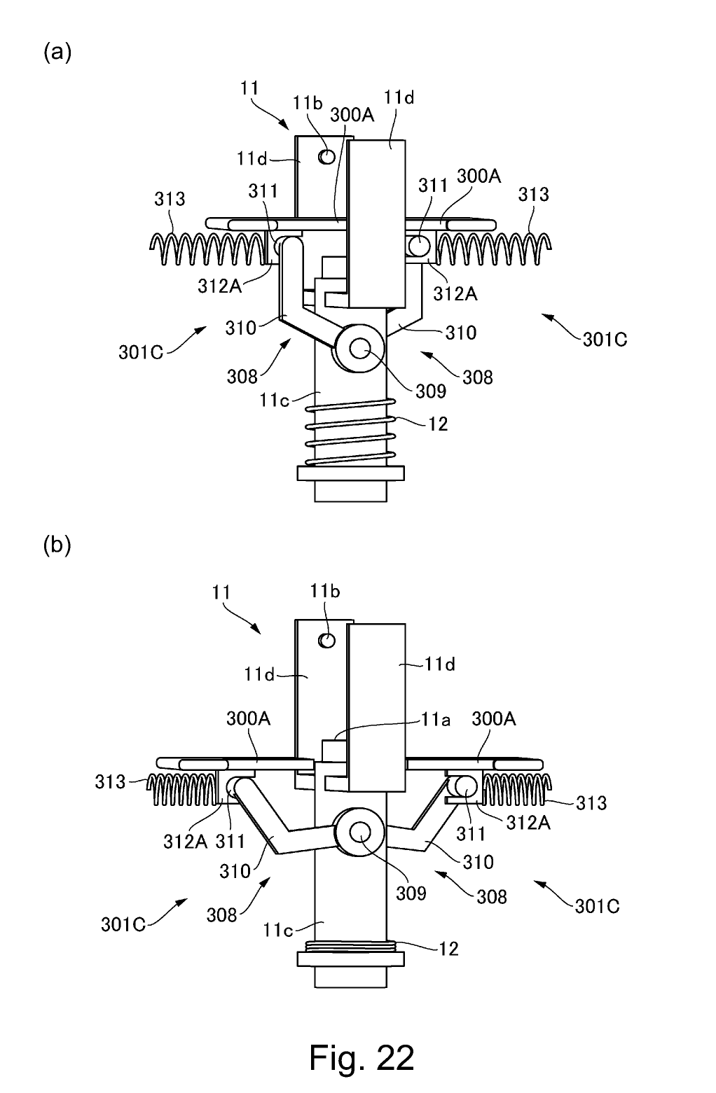

Referring to FIG. 22, a fourth embodiment will be described, in which the present invention is embodied in a developer supplying apparatus 200 provided with the above-described developer receiving portion 11 and developer supply container 1. In this embodiment, a spring 313 for urging the covering member 300A in the covering direction is provided. In the description of this embodiment, the same reference numerals as in Embodiment 3 are assigned to the elements having the corresponding functions in this embodiment, and the detailed description thereof is omitted for simplicity.

The covering member moving mechanism 301C as the covering member moving means of this embodiment includes a spring 313 as an urging means for urging the covering member 300A toward the covering position. More specifically, the spring 313 is disposed between a shaft receiving portion 312A integral with a covering member 300 and a fixed portion of the developer receiving apparatus 8, and urges the covering member 300A toward the covering position. In the illustrated example, the spring 313 is a compression coil spring which applies an urging force to the covering member 300A in the sliding direction.

The shaft receiving portion 312A of this embodiment is provided with a cut-away portion at a side of the supporting hole supporting the second shaft 311 where the covering member 300A moves toward the covering position. Through the cut-away portion, the second shaft 311 can be placed in the supporting hole of shaft receiving portion 312. Also in this embodiment, similarly to the third embodiment, the second shaft 311 may be placed in a supporting hole not having the cut-away portion.

In the case of this embodiment, with such a structure, when the developer supply container 1 is mounted to the developer receiving apparatus 8, the developer receiving portion 11 is raised in interrelation with the mounting operation, and one end portion of the swingable arm 310 supported by the first shaft 309 starts to move. Then, the second shaft 311 fixed to the other end portion of the swingable arm 310 slides while it is in engagement with the guiding surface 307a1 (part (c) of FIG. 21) of the guide groove 307a, and the swingable arm 310 rotates about the first shaft 309 in such a direction that the other end portion is away from the developer receiving portion 11. At this time, the second shaft 311 is guided by the guide groove 307a. Therefore, the covering member 300A supported by the second shaft 311 the shaft receiving portion 312 also moves toward the open position (part (b) of FIG. 22) against the urging force of the spring 313.

On the other hand, when the developer supply container 1 is dismounted from the developer receiving apparatus 8, the developer receiving portion 11 moves in the direction of dismounting from the developer supply container 1 in interrelation with the dismounting operation, and the one end portion of the swingable arm 310 supported by the first shaft 309 starts to move in the same direction Then, the swingable arm 310 rotates about the first shaft 309 in such a direction that the other end portion moves toward the developer receiving portion 11, while the second shaft 311 fixed to the other end portion of the swingable arm 310 is in engagement with the guiding surface 307a2 (part (c) of FIG. 21) of the guide groove 307a. At this time, since the covering member 300A is urged toward the covering position (part (a) of FIG. 22) by the spring 313, the second shaft 311 moves along the guide groove 307a. Then, the covering member 300A supported by the second shaft 311 through the shaft receiving portion 312 also moves toward the covering position.

Furthermore, the covering member 300A may be urged toward the open position by a spring. However, with this structure, the cut-away portion of the supporting hole supporting the second shaft 311 of the shaft receiving portion 312A is provided in a side where the covering member 300A moves toward the open position. By this, when the developer supply container 1 is mounted to the developer receiving apparatus 8, the developer receiving portion 11 is raised in interrelation with the mounting operation, and the second shaft 311 moves away from the developer receiving portion 11 by the rotation of the swingable arm 310. And, the covering member 300A is moved toward the open position by the urging force of the spring. On the other hand, when the developer supply container 1 is dismounted from the developer receiving apparatus 8, the developer receiving portion 11 moves in the direction of dismounting from the developer supply container 1 in interrelation with the dismounting operation. Then, the second shaft 311 is moved toward the developer receiving portion 11 by the rotation of the swingable arm 310, and the covering member 300A moves toward the covering position against the urging force of the spring.

In the case of the present invention, in interrelation with the movement of the developer receiving portion caused by the mounting operation of the developer supply container, the covering member is moved from the covering position to the open position. Therefore, in the structure in which by moving the developer receiving portion having a receiving opening for receiving the developer, the receiving opening is connected with a discharge opening of the developer supply container, the entering of the foreign matter into the receiving opening can be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application <add other application numbers, if appropriate>which is <or are, if more than one>hereby incorporated by reference herein in its<or their, if more than one>entirety.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 167338/2013 filed Aug. 12, 2013, which is hereby incorporated by reference.

What is claimed is:

1. A supplying apparatus comprising:
a mounting portion configured to mount a supply container accommodating a developer, wherein said supply container includes a discharge opening detachably mountable to said mounting portion and configured to discharge the developer;
a receiving portion capable of receiving the developer, said receiving portion including a receiving opening which opens upwardly and which is connectable with said discharge opening to receive the developer discharged through said discharge opening when said supply container is mounting to said mounting portion;
a first moving mechanism configured to move said receiving portion to and away from a position of said discharge opening in interrelation with mounting and demounting operation of said supply container;
a covering member provided in a position opposing and above said receiving opening and movable between a covering position covering said receiving opening and an open position opening said receiving opening; and
a second moving mechanism configured to move said covering member from the covering position to the open position with the mounting operation of said supply container.

2. An apparatus according to claim 1, wherein said second moving mechanism moves said covering member from the covering position to the open position with a movement of said receiving portion caused by the mounting operation of said supply container.

3. An apparatus according to claim 1, wherein said first moving mechanism includes an engaging portion provided in one of said supply container and said receiving portion, and a guide portion provided in the other, said guide portion being capable of engaging with said engaging portion in the mounting and demounting operation of said supply container to guide said engaging portion so as to move said receiving portion.

4. An apparatus according to claim 1, wherein said second moving mechanism includes an urging portion configured to urge said covering member toward the covering position or the open position.

5. An apparatus according to claim 1, wherein said second moving mechanism includes a rotational shaft configured to rotatably support said covering member between the covering position and the open position, and a rotating portion configured to impart a relative movement between said covering member and said receiving portion and rotating said covering member about said rotational shaft with the movement of said receiving portion.

6. An apparatus according to claim 5, wherein said rotational shaft is non-movable in a moving direction of said receiving portion, and wherein said rotating portion is provided with an engaging projection provided on said receiving portion and projecting in parallel with said rotational shaft, and said rotating portion is provided with a engaged portion provided on said covering member and engaged with said engaging projection, said engaged portion rotates said covering member about said rotational shaft by relative movement of said engaging projection with the movement of said receiving portion.

7. An apparatus according to claim 1, wherein said second moving mechanism includes a slide guiding portion configured to guide sliding of said covering member between the covering position and the open position in a direction crossing with a moving direction of said receiving portion a sliding operation portion configured to impart a relative movement between said covering member and said receiving portion and to move said covering member along said slide guiding portion in accordance with the movement of said receiving portion.

8. An apparatus according to claim 7, wherein said sliding operation portion includes a first shaft provided on said receiving portion and extending in a direction perpendicular to the moving direction of said receiving portion and to a guiding direction of said slide guiding portion, a swingable arm swingably supported on said first shaft at one end portion, and a second shaft rotatably supporting the other end portion of said swingable arm.

9. An apparatus according to claim 1, wherein said covering member includes a first cover portion configured to cover a part of said receiving opening and a second cover portion separable from said first cover portion and configured to cover a part of said receiving opening, and wherein said first cover portion and said second cover portion rotate in the directions opposite to each other to move from the covering position to the open position in interrelation with the mounting operation of said supply container.
